(19) United States
(12) Patent Application Publication
(10) Pub. No.: US 2025/0070632 A1
(43) Pub. Date: Feb. 27, 2025

(54) PROPULSION MOTOR TOPOLOGIES

(71) Applicant: HYPERLOOP TECHNOLOGIES, INC., Dubai (AE)

(72) Inventors: Yingjie LI, Palo Alto, CA (US); Ju Hyung KIM, Los Angeles, CA (US); Alexander JEDINGER, Long Beach, CA (US)

(21) Appl. No.: 18/723,831

(22) PCT Filed: Dec. 22, 2022
(86) PCT No.: PCT/US2022/053793

§ 371 Date: Jun. 24, 2024

Related U.S. Application Data
(60) Provisional application No. 63/293,670, filed on Dec. 24, 2021.
(60) Provisional application No. 63/293,674, filed on Dec. 24, 2021.
(60) Provisional application No. 63/293,677, filed on Dec. 24, 2021.
(60) Provisional application No. 63/293,681, filed on Dec. 24, 2021.

(51) Int. Cl. H02K 41/03

(52) U.S. Cl. CPC H02K 41/03; H02K 2213/03

(57) ABSTRACT

Various propulsion motor topologies are provided. In particular, a propulsion motor is provided which includes: at least one ferromagnetic core having opposite ends joined by a body forming a magnetic flux pathway between the opposite ends; a magnetic flux inducing device to induce a first magnetic flux in the at least one ferromagnetic core along the magnetic flux pathway; and armature coils to induce a varying second magnetic flux in the at least one ferromagnetic core perpendicular to the magnetic flux pathway, to assist inducing a propulsion force perpendicular to the magnetic flux pathway. The at least one ferromagnetic core is shaped to form one or more total forces perpendicular to the propulsion force due to the first magnetic flux.

### CROSS-REFERENCE TO RELATED APPLICATIONS

The present application claims priority from U.S. Patent Application No. 63/293,670, filed on Dec. 24, 2021, and from U.S. Patent Application No. 63/293,674, filed on Dec. 24, 2021, and from U.S. Patent Application No. 63/293,677 filed on Dec. 24, 2021, and from U.S. Patent Application No. 63/293,681, filed on Dec. 24, 2021, the contents of all of which are incorporated herein by reference.

### BACKGROUND

The constraints of a transportation system that seeks to promote high speed, high efficiency, and high-power density, impose challenges that are not present in the state of the art, in particular to propel a payload and/or a vehicle along a track using a propulsion motor, and one or more of guide and levitate the propulsion motor relative to the track.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a view of a high-speed transport system that includes a track and track segments, according to non-limiting examples.

FIG. 2A depicts a perspective view of a homopolar linear synchronous motor, according to non-limiting examples.

FIG. 2B depicts a front view of the homopolar linear synchronous motor, according to non-limiting examples.

FIG. 3A depicts a side view of a track segment, which may be used to form a track of a high-speed transport system, and a portion of a propulsion motor that includes a field coil as a magnetic flux inducing device, as well as magnetic flux pathways, according to non-limiting examples.

FIG. 3B depicts a front-end view of the track segment of FIG. 3A, with the portion of a propulsion motor shown in outline, as well as the magnetic flux pathways, the according to non-limiting examples.

FIG. 3C depicts a side view of a track segment, which may be used to form a track of a high-speed transport system, and a portion of a propulsion motor that includes a magnet as a magnetic flux inducing device, as well as magnetic flux pathways, according to non-limiting examples.

FIG. 4A depicts a side view of a track segment and a portion of a propulsion motor having a 90 degree configuration, according to non-limiting examples.

FIG. 4B depicts a perspective view a homopolar linear synchronous motor adapted according to the configuration of FIG. 4A, according to non-limiting examples.

FIG. 4C depicts a front view the homopolar linear synchronous motor adapted according to the configuration of FIG. 4A, according to non-limiting examples.

FIG. 5 depicts a side view of a track segment and a portion of a propulsion motor having a 270 degree configuration, according to non-limiting examples.

FIG. 6 depicts a side view of a track segment and a portion of a propulsion motor having a 180 degree configuration, oriented to generate a levitation force, according to non-limiting examples.

FIG. 7 depicts a side view of a track segment and a portion of a propulsion motor having a 180 degree configuration, oriented to generate a guidance force, according to non-limiting examples.

FIG. 8 depicts a side view of a track segment and a portion of a propulsion motor having a mirror-image symmetric 90 degree configuration, relative to a center plane, oriented to generate a guidance force, according to non-limiting examples.

FIG. 9 depicts a side view of a track segment and a portion of a propulsion motor having a mirror-image symmetric 270 degree configuration, relative to a center plane, oriented to generate a guidance force, according to non-limiting examples.

FIG. 10 depicts a side view of a track segment and a portion of a propulsion motor having a mirror-image symmetric 90 degree configuration, relative to a center plane, oriented to generate a levitation force, according to non-limiting examples.

FIG. 11 depicts a side view of a track segment and a portion of a propulsion motor having a mirror-image symmetric 270 degree configuration, relative to a center plane, oriented to generate a levitation force, according to non-limiting examples.

FIG. 12A depicts a side view of a track segment and a portion of a propulsion motor having a paired ferromagnetic core configuration, with the track segments having a 180 degree configuration, according to non-limiting examples.

FIG. 12B depicts a side view of a track segment and a portion of a propulsion motor having a paired ferromagnetic core configuration, with the ferromagnetic core having a 180 degree configuration, according to non-limiting examples.

FIG. 13 depicts a side view of a track segment and a portion of a propulsion motor having an almost 360 degree configuration, according to non-limiting examples.

FIG. 14 depicts an end view of an example vehicle and a track, the vehicle having propulsion motors that generate guidance forces and levitation forces, according to non-limiting examples.

FIG. 15 depicts an end view of another example vehicle and a track, the vehicle having propulsion motors that generate guidance forces and levitation forces, according to non-limiting examples.

### DETAILED DESCRIPTION

The constraints of a transportation system that seeks to promote high speed, high efficiency, and high-power density, impose challenges that are not present in the state of the art, in particular to propel a and/or a vehicle along a track using a propulsion motor, and one or more of guide and levitate the propulsion motor relative to the track.

In particular, propulsion motors may be attached to a payload to form a vehicle. The propulsion motors propel the payload and/or the vehicle along a track and generally include: at least one ferromagnetic core; a magnetic flux inducing device (e.g. such as field coils and/or magnets) to induce a first magnetic flux in the at least one ferromagnetic core along a magnetic flux pathway formed in combination with ferromagnetic track segments of the track; armature coils to induce a varying second magnetic flux in the at least one ferromagnetic core perpendicular to the magnetic flux pathway, thereby inducing a propulsion force perpendicular to the magnetic flux pathway in combination with the ferromagnetic track segments of the track. It is hence understood that ferromagnetic cores of a propulsion motor are generally adjacent to, and/or between the ferromagnetic track segments of the track; for example, the ferromagnetic track segments of the track may be C-shaped, and the ferromagnetic cores of the propulsion motor may be generally block shaped and/or rectangular, and the like, in cross-section to fit between opposing ends of the C-shaped ferromagnetic track segments.

As such, the ferromagnetic core of the propulsion motor should be positioned relative to the ferromagnetic track segments of the track in a consistent manner, as the propulsion motor moves along the track. As such, in addition to at least one propulsion motor, a payload and/or a vehicle may be provided with one or more of: at least one guidance actuator, to laterally control the position of ferromagnetic cores of a propulsion motor “left” and “right” relative to the ferromagnetic track segments of a track; and/or at least one levitation actuator to levitate the propulsion motor (e.g. oppose gravity), relative to the track, to control the position of the ferromagnetic cores “up” and “down” relative to the ferromagnetic track segments, all while the propulsion motor propels the payload along the track. However, such combinations of a propulsion motor, and one more of a guidance actuator, and/or a levitation actuator, may introduce undue complexity into the payload and/or the vehicle, and which may also be challenging to control.

Hence, provided herein are different topologies (e.g. geometric configurations) for propulsion motors that provide, in combination with track segments of a track, both a propulsion force to propel a payload along a track, and one or more forces perpendicular to the propulsion force, that may comprise a guidance force and/or a levitation force. Such additional forces may be achieved by selecting appropriate geometric configurations of ferromagnetic cores of a propulsion motor, as well as complementary geometric configurations of ferromagnetic track segments of a track.

Furthermore, provided herein are vehicles that include one or more of the propulsion motors that provide, in combination with track segments of a track, both a propulsion force to propel a payload along a track, and one or more forces perpendicular to the propulsion force. A first portion of the propulsion motors may provide a respective guidance force, in addition to a respective propulsion force, and a second portion of the propulsion motors may provide a respective levitation force, in addition to a respective propulsion force. However, some vehicles may include propulsion motors that provide a respective guidance force, in addition to a respective propulsion force, but without propulsion motors that provide a respective levitation force; conversely, some vehicles may include propulsion motors that provide a respective levitation force, in addition to a respective propulsion force, but without propulsion motors that provide a respective guidance force. Furthermore, in these example, the track may comprise a plurality of tracks at different sides of the vehicle, for example adjacent to where the various propulsion motors are located.

An aspect of the present specification provides a propulsion motor comprising: at least one ferromagnetic core having opposite ends joined by a body forming a magnetic flux pathway between the opposite ends; a magnetic flux inducing device to induce a first magnetic flux in the at least one ferromagnetic core along the magnetic flux pathway; and armature coils to induce a varying second magnetic flux in the at least one ferromagnetic core perpendicular to the magnetic flux pathway, to assist inducing a propulsion force perpendicular to the magnetic flux pathway, the at least one ferromagnetic core shaped to form one or more total forces perpendicular to the propulsion force due to the first magnetic flux.

Another aspect of the present specification provides a propulsion motor comprising: ferromagnetic cores having respective opposite ends joined by a respective body forming a magnetic flux pathway between the opposite ends; a magnetic flux inducing device to induce a first magnetic flux in the ferromagnetic cores along the magnetic flux pathway; and armature coils to induce respective varying second magnetic flux in the ferromagnetic cores perpendicular to the magnetic flux pathway, to assist inducing a propulsion force perpendicular to the magnetic flux pathway, the ferromagnetic cores arranged in pairs, such that a pair of the ferromagnetic core comprises: a first ferromagnetic core comprising first opposite ends; and a second ferromagnetic core comprising second opposite ends, wherein the first opposite ends and the second opposite ends are about parallel to each other, and are respectively configured to interact with respective ends of a track segment of a track that completes, in combination with the first ferromagnetic core and the second ferromagnetic core, the magnetic flux pathway, and wherein two respective forces are formed, perpendicular to the first opposite ends and the second opposite ends, and perpendicular to the propulsion force, the two respective forces of about equal magnitude, but opposite in direction, such that a total force on the first opposite ends and the second opposite ends, due to the two respective forces, is zero.

Another aspect of the present specification provides a vehicle configured to move along a track, the vehicle comprising: a payload; and one or more propulsion motors mounted to the payload, the one or more propulsion motors configured to form, in combination with track segments of the track: a propulsion force in a direction of the track; and one or more total forces perpendicular to the propulsion force configured to one or more of oppose gravity and laterally guide the one or more propulsion motors relative to the track.

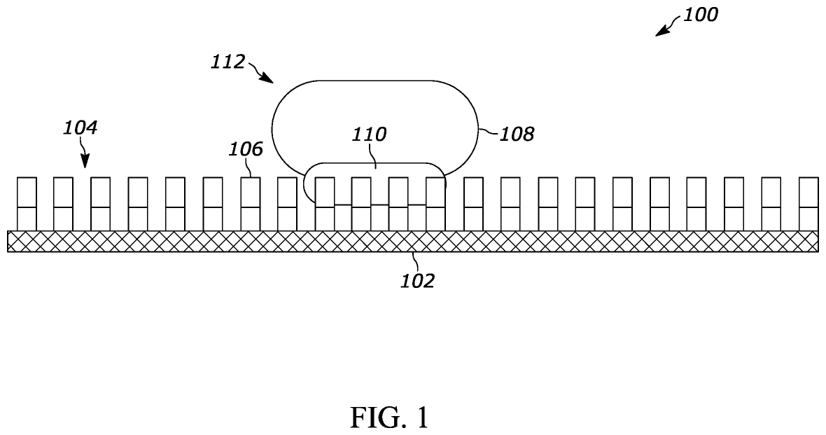

Attention is directed to FIG. 1 which schematically depicts a view of a high-speed transport system 100. As depicted, the system 100 includes a fixed surface and/or a wall 102 (depicted in cross-section) which supports a track 104 comprising track segments 106 spaced periodically along the wall 102. In some examples, the wall 102 may be a wall, and/or an interior of a tube, which may be evacuated and/or at least partially evacuated using vacuum pumps (not depicted) and the like, to form in a low-pressure environment. However, in other examples the tube may not be evacuated and/or the wall 102, the track 104 are not in a low-pressure environment. Furthermore, the wall 102 may not be a wall of a tube, but may be a wall of any suitable structure and/or fixed surface which supports the track 104. The wall 102 may further comprise corners to which the track segments 106 may be mounted. Furthermore, the high-speed transport system 100 may be deployed on land, underground, overland, overwater, underwater, and the like.

As depicted, the system 100 includes a payload 108, and the like, for transporting cargo and/or passengers, and the like, and/or any other suitable payloads. The payload 108 may be aerodynamically shaped. The system 100 further includes at least one propulsion motor 110 attached to the payload 108 which interact with the track segments 106 to move the payload 108 along the track 104. Any suitable number of propulsion motors 110 may be attached to the payload 108 in any suitable configuration. Indeed, together, the payload 108 and the any suitable number of propulsion motors 110 may together form a vehicle 112 that is propelled along the track 104 by the propulsion motor 110. Similarly, the track 104 and the track segments 106 may be located on one or more sides of a tube, and the like, that include the wall 102, with any geometry of a propulsion motor 110 attached to the payload 108 adjusted accordingly; put another way, the track 104 may comprise a plurality to tracks 104 positioned to interact with a plurality of propulsion motors 110 attached to the payload 108 in any suitable configuration.

In general, the track segments 106 and the propulsion motor 110, form a homopolar linear synchronous machine. The propulsion motor 110 may be substantially attached to the payload 108. The propulsion motor 110 may be attached to the payload 108 in any of one or more orientations, such as on the top, bottom, and side of the payload 108, so long as a corresponding track segment 106 is substantially connected to the wall 102 in an orientation that allows the propulsion motor 110 to pass through a track segment 106 in a direction of motion. The track segments 106 may be attached to the wall 102 in any suitable orientation, so long as the propulsion motor 110 have a substantially matching orientation to allow the propulsion motor 110 to pass through the track segments 106.

While not depicted, the system 100 may further comprise a suspension and/or location system to suspend and/or locate the propulsion motor 110 relative to the track segments 106. Such a suspension and/or location system may be mechanical (e.g. wheels and a corresponding track therefor), and/or electromagnetic (e.g. a maglev system), and/or of any other suitable configuration. While not depicted, the system 100 may further comprise a guidance system to guide and/or steer the payload 108 relative to the track 104 and/or the track segments 106, and/or onto other walls (e.g. of other tubes) that connect to the wall 102. However, as will be described herein, propulsion motors 110 described herein may be adapted to both propel the payload 108 relative to the track 104, and provide one or more of: a guidance force to guide and/or steer the payload 108 relative to the track 104 and/or the track segments 106; and a levitation force to suspend and/or locate the propulsion motor 110 relative to the track segments 106.

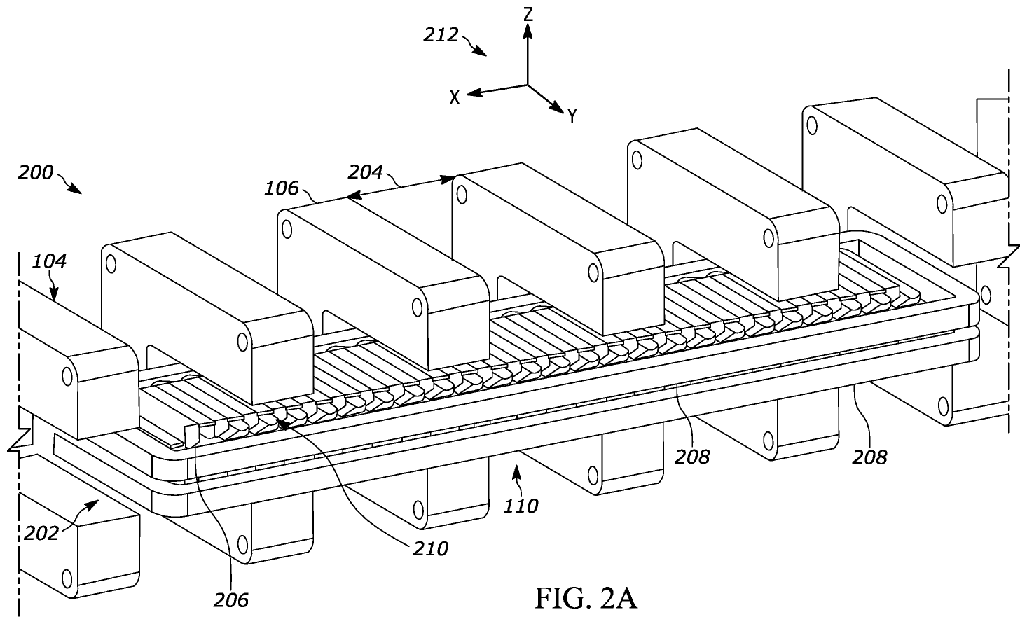

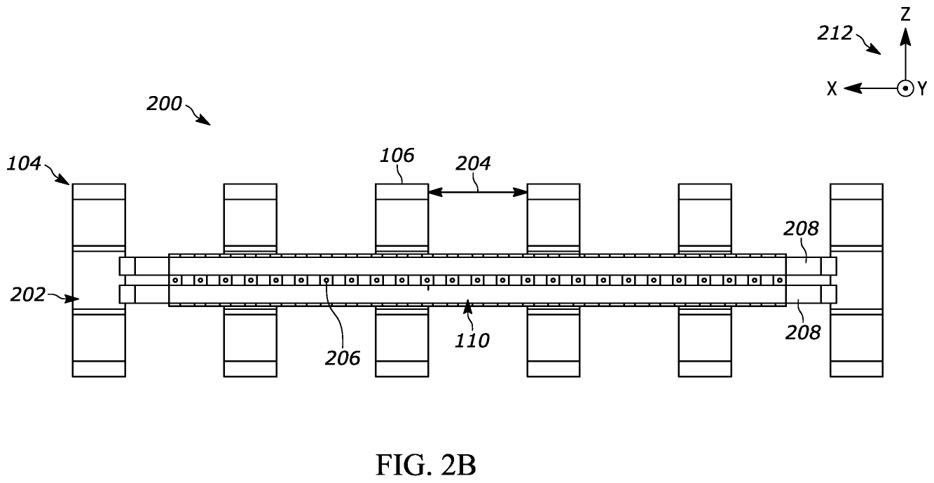

Attention is next directed to FIG. 2A and FIG. 2B which respectively depict perspective view and a side view of a homopolar linear synchronous machine (HLSM) 200 according to present examples. In particular FIG. 2A depicts a perspective view of a portion of the track 104, including a portion of the track segments 106 and an example propulsion motor 110. As depicted, the track segments 106 may be substantially C-shaped and/or horseshoe shaped, and the like, such that a propulsion motor 110 may pass through a center “hollow” portion 202 of a track segment 106, as seen in both FIG. 2A and FIG. 2B. As depicted, the propulsion motor 110 is passing through a plurality of track segments 106. The track 104, and specifically the track segments 106, may function as a “stator” of the HLSM 200, and the propulsion motor 110 may function as a “rotor” of the HLSM 200, such that, together, the track 104 (e.g. the track segments 106) and the propulsion motor 110 form the HLSM 200.

As depicted, the HLSM 200, as described herein, may include two or more laterally offset track segments 106, such that there is a gap 204 between adjacent track segment 106. Hence, the track segments 106 are generally magnetically salient, such that a varying magnetic flux may be produced across the track segments 106 and the gaps 204, for example by at least magnetic flux inducing device of the propulsion motor 110, such as at least one field coil and/or a at least one magnet, described in more detail below.

Such magnetic flux may be about constant in a track segment 106, and the resulting magnetic flux in the gap 204 varies, relative to the flux in a track segment 106, in a direction of motion (e.g. along the track 104).

In particular, the propulsion motor 110 comprises at least one ferromagnetic core 206 having opposite ends joined by a body forming a magnetic flux pathway between the opposite ends. For example as depicted, the propulsion motor 110 comprises a plurality of ferromagnetic cores 206, arranged along the track 104 and/or along a longitudinal axis of the propulsion motor 110, that are block shaped and/or rectangular in cross-section that are shaped to fit into the hollow portions 202 of the track segments 106. The magnetic flux pathway formed by the at least one ferromagnetic core 206 is understood to complete a magnetic flux pathway formed in the track segments 106, for example, with each track segment 106 forming a respective portion of a magnetic flux pathway completed by respective ferromagnetic cores 206.

The propulsion motor 110 further comprises at least one magnetic flux inducing device 208 to induce a first magnetic flux in the at least one ferromagnetic core 206 along the magnetic flux pathway. As depicted, the at least one magnetic flux inducing device 208 comprises a pair of field coils that induce a first magnetic flux in the at least one ferromagnetic core 206 along the magnetic flux pathway and through respective track segments 106; however, the at least one magnetic flux inducing device 208 may comprise any suitable combination of one or more field coils. The at least one magnetic flux inducing device 208 may alternatively comprise magnets, for example embedded in the ferromagnetic cores 206.

The propulsion motor 110 further comprises armature coils 210 (as best seen in FIG. 2A) to induce a varying second magnetic flux in the at least one ferromagnetic core 206 perpendicular to the magnetic flux pathway formed by the at least one ferromagnetic core 206 and the track segments 106, to induce a propulsion force perpendicular to the magnetic flux pathway. In general, the armature coils 210 of the propulsion motor 110 may generate the second magnetic flux through the track segments 106 that results in pole pairs (e.g. a sequence of magnetically-polarized regions) which interact with the magnetic flux, generated by the at least one magnetic flux inducing devices 208, to propel the propulsion motor 110 along the track 104.

In particular, the track segments 106 are arranged such that the hollow portions 202 of the track segments 106 form a substantially continuous path for the propulsion motor 110, and specifically the propulsion motor 110, to move relative to the track segments 106 and/or the track 104. Hence, a track 104 and/or track segments 106, may be substantially fixed relative to the propulsion motor 110 of the HLSM 200. Together, the track 104 and the propulsion motor 110 comprise a propulsion system for moving the payload 108 and/or the vehicle 112 relative to the wall 102, in either direction along the track 104. In particular, the propulsion motor 110 is propelled along the track 104 using magnetic flux produced by the propulsion motor 110, as described, for example, in Applicant's co-pending application titled “HOMOPOLAR LINEAR SYNCHRONOUS MACHINE” having PCT Patent Application No. PCT/US2019/051701, filed Sep. 18, 2019, and which claims priority from U.S. Patent Application No. 62/733,551, filed Sep. 19, 2018, and the contents of each are incorporated herein by reference.

For clarity, an XYZ Cartesian coordinate system 212 is depicted in FIG. 2A and FIG. 2B, showing a convention that will be used throughout the present specification. For example, an “X” axis is understood to be along the track 104, a “Y” axis is understood to be in a “left” and “right” direction, lateral to the track 104, for example in a direction between backs of track segments 106 and hollow portions 202, and the “Z” axis is understood to be in an “up” and “down” direction.

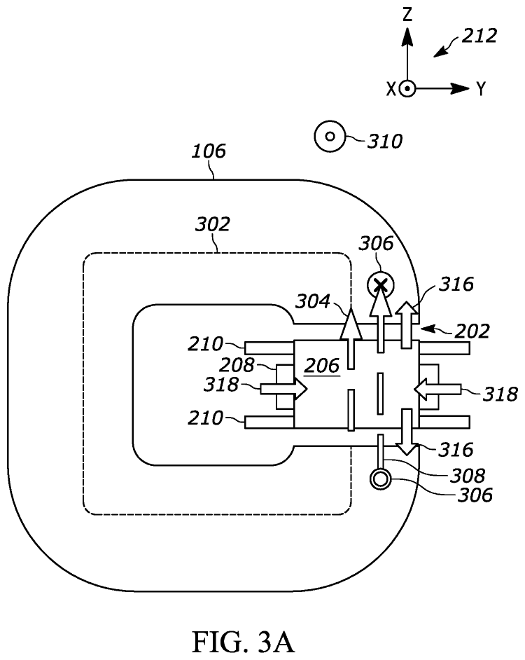

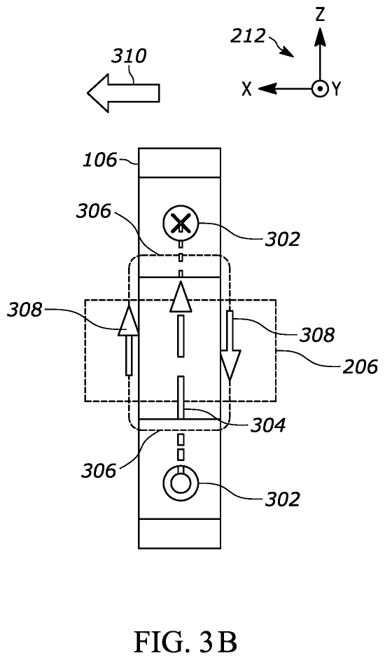

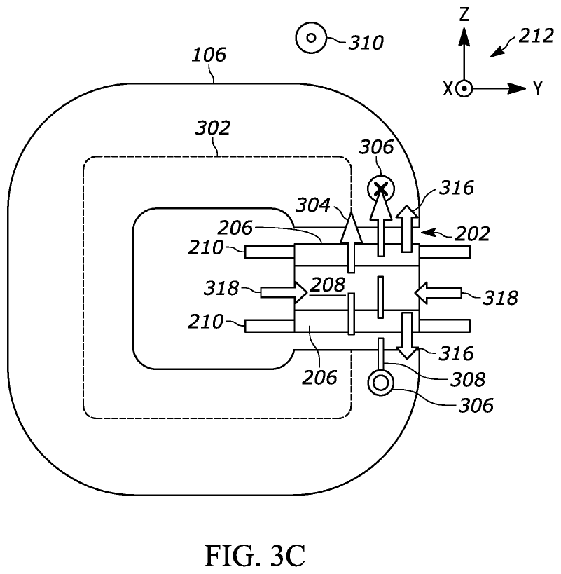

Attention is next directed to FIG. 3A, 3B and FIG. 3C. FIG. 3A and FIG. 3C schematically depict a side view of a C-shaped track segment 106 in combination with different configurations of ferromagnetic cores 206, magnetic flux inducing devices 208 and armature coils 210 of the propulsion motor 110. FIG. 3B schematically depicts a front view of either of the configurations of FIG. 3A and FIG. 3C with locations of components of the propulsion motor 110 indicated in dashed lines; FIG. 3B is provided merely to better show relationships between magnetic flux pathways of the configurations of FIG. 3A and FIG. 3C, which are generally the same.

It is understood that only a portion of the ferromagnetic cores 206, magnetic flux inducing devices 208 and armature coils 210 are depicted in FIG. 3A and FIG. 3C, for example in cross-section, merely to show their positions relative to each other and the track segment 106 (e.g. inside the hollow portion 202) during operation, as well to show a general shape of the ferromagnetic cores 206.

Also shown in FIG. 3A, FIG. 3B, and FIG. 3C is a first magnetic flux pathway 302, along which a first magnetic flux 304 generated by the one or more magnetic flux inducing devices 208 of the propulsion motor 110 is induced.

Also shown in FIG. 3A, FIG. 3B, and FIG. 3C is a second magnetic flux pathway 306, which is understood to form closed loop in a plane formed by the “XZ” axes of the coordinate system 212. As best seen by comparing FIG. 3A and/or FIG. 3C with FIG. 3B, the second magnetic flux pathway 306 is about perpendicular to the first magnetic flux pathway 302, and/or transverse to the first magnetic flux pathway 302, and second magnetic flux 308 generated by the armature coils 210 is understood to flow along the second magnetic flux pathway 306. It is understood that the current in the armature coils 210 is varied such that the second magnetic flux 308 is varied, and a propulsion force 310 is formed in a direction of the “X” axis of the coordinate system 212, for example along the track 104. Put another way, the armature coils 210 generally induce the varying second magnetic flux 308 in the at least one ferromagnetic core 206 perpendicular to the first magnetic flux pathway 302, to assist inducing a propulsion force 310 perpendicular to the first magnetic flux pathway 302. While the propulsion force 310 is depicted being in a particular direction along the “X” axis of the coordinate system 212, the propulsion force 310 may alternatively be in an opposite direction depending, for example, on control of current in the armature coils 210. Hence, a propulsion force 310 may be generated that moves the propulsion motor 110 and/or the payload 108 and/or the vehicle 112 in either direction along the track 104.

While two armature coils 210 are depicted in particular positions relative to the ferromagnetic cores 206, such depictions are merely to indicate that the propulsion motor 110 comprises a plurality of armature coils 210, which can be arranged in any suitable configuration.

In FIG. 3A it is understood that the one or more magnetic flux inducing devices 208 comprises one or more field coils around the ferromagnetic core 206, while in FIG. 3C it is understood that the one or more magnetic flux inducing devices 208 comprises a magnet embedded in, and/or arranged relative to, the ferromagnetic core 206. Either of configurations results in inducing the first magnetic flux 304 along the first magnetic flux pathway 302.

However, in order to maintain the position of the ferromagnetic core 206 in both the “Y” axis of the coordinate system 212 and the “Z” axis of the coordinate system 212, a vehicle 112 having a propulsion motor 110 having configurations and/or topologies of ferromagnetic core 206 depicted in FIG. 3A and FIG. 3C may need to be provided with at least guidance motor to laterally control the position of the propulsion motor 110 side-to-side in the hollow portions 202, and at least one levitation motor to control the position of the propulsion motor 110 up and down in the hollow portions 202, and the like (e.g. mechanical devices, such as wheels, may alternatively be used to at least partially control the up and down position along the “Z” axis of the coordinate system 212).

Furthermore, while as depicted ends of the ferromagnetic core 206 form forces 316 that generally attract the ferromagnetic core 206 to respective ends of the track segment 106, such forces 316 are of generally a same magnitude but opposite in direction such that the forces 316 cancel each other out and/or a total force is “0”. Similarly, the ends of the ferromagnetic core 206 form forces 318 that generally attract the ferromagnetic core 206 into a center of the hollow portion 202, such forces 318 are of generally a same order of magnitude but opposite in direction; hence, the forces 318 generally oppose each other to center the ferromagnetic core 206; however such centering may not be sufficient to maintain a “side-to-side” position of the ends of the ferromagnetic core 206.

Hence, to partially obviate such complexities, a propulsion motor as provided herein may be adapted to provide one or more forces perpendicular to the propulsion force 310 as described hereafter, for example to provide one or more of a levitation force and a guidance force.

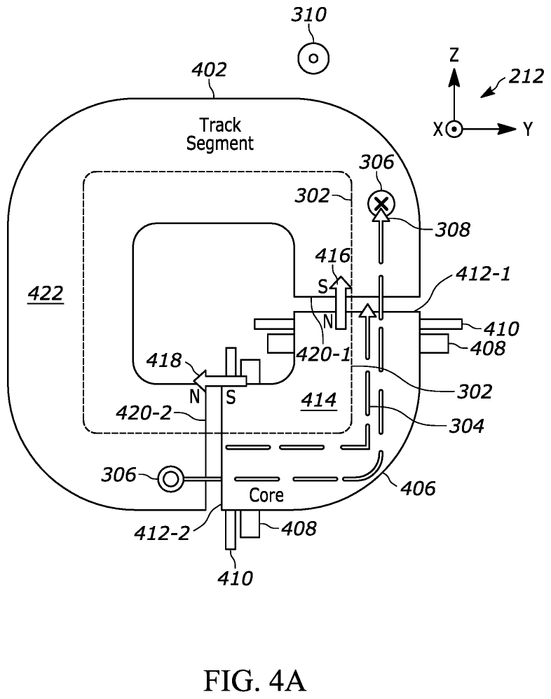

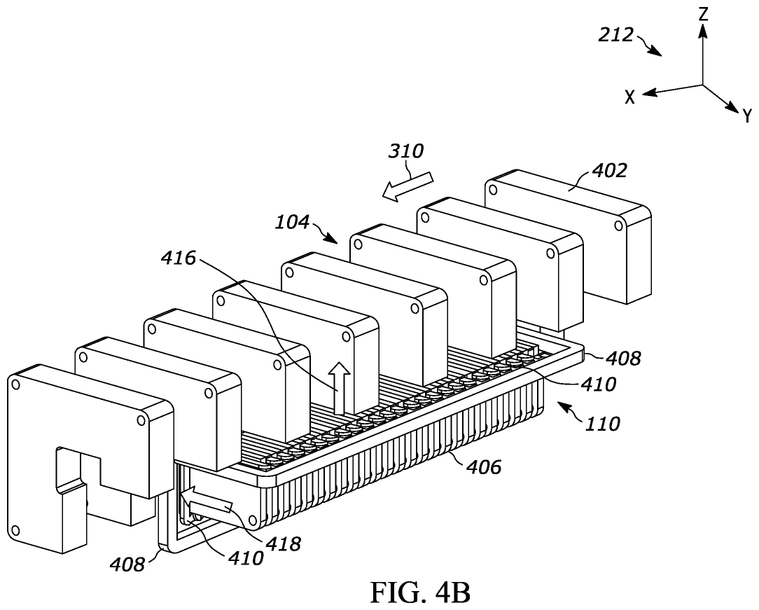

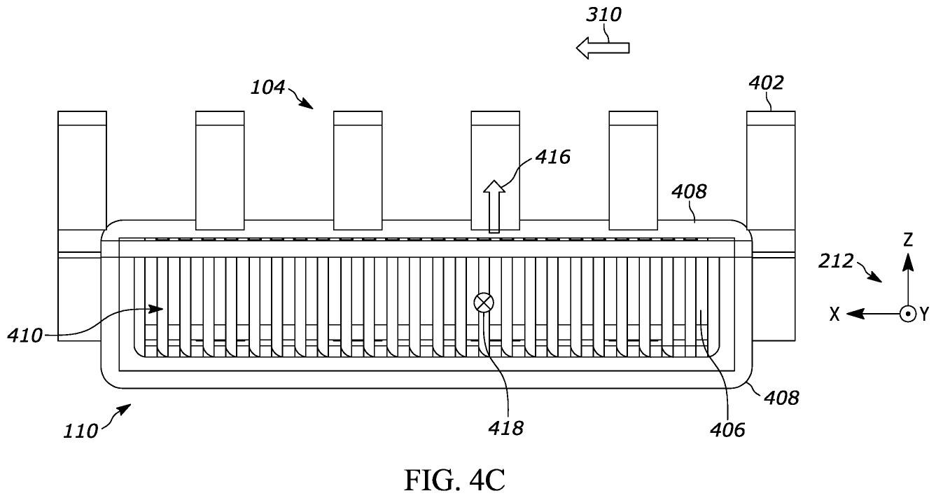

For example, attention is next directed to FIG. 4A, FIG. 4B and FIG. 4C. FIG. 4A depict a side view of a track segment 402 in combination with a configuration of a ferromagnetic core 406, magnetic flux inducing devices 408 and armature coils 410, that may be used in place of the configurations shown in FIG. 3A and FIG. 3C.

FIG. 4B depicts a perspective view of the track 104 and propulsion motor 110 adapted according to the configuration shown in FIG. 4A. FIG. 4C depicts a front view of the track 104 and propulsion motor 110 adapted according to the configuration shown in FIG. 4A. The coordinate system 212 is depicted in each of FIG. 4A, FIG. 4B and FIG. 4C to show relative orientations of the components depicted.

In particular, as best seen in FIG. 4A, the propulsion motor 110 has been adapted relative to FIG. 3A and FIG. 3C, such that the propulsion motor 110 comprises: at least one ferromagnetic core 406 having opposite ends 412-1, 412-2 joined by a body 414 forming the first magnetic flux pathway 302 at least between the opposite ends 412-1, 412-2 (e.g. and completed by the track segment 402); at least one magnetic flux device 408 (e.g. as depicted two field coils 408 located at respective opposite ends 412-1, 412-2) to induce the first magnetic flux 304 in the at least one ferromagnetic core 406 along the magnetic flux pathway 302; and armature coils 410 to induce a varying second magnetic flux 308 (e.g. along the second magnetic flux pathway 306) in the at least one ferromagnetic core 406 perpendicular to the first magnetic flux pathway 302, to assist inducing the propulsion force 310 perpendicular to the first magnetic flux pathway 302. Hereafter, the opposite ends 412-1, 412-2 are interchangeably referred to as the ends 412-1, 412-2, and/or collectively, as the opposite ends 412 and/or the ends 412, and, generically, as an opposite end 412 and/or an end 412. This convention will be used throughout the present specification.

However, in contrast to the configuration depicted in FIG. 3A and FIG. 3C, the at least one ferromagnetic core 406 is shaped to form one or more total forces 416, 418 perpendicular to the propulsion force 310 due to the first magnetic flux 304. For example, as depicted, the body 414 has an “L” shape and/or a corner shape, and/or is shaped such that the opposite ends 412 are at about 90 degrees relative to each other. Put another way, the body 414 is shaped such that about 25% of the first magnetic flux pathway 302 is around the body 414, and the remaining 75% of the first magnetic flux pathway 302 is around the track segment 402, which is shaped accordingly. Put yet another way, as the first magnetic flux pathway 302 forms a closed loop, the first magnetic flux pathway 302 may be described as covering a 360 degree path; hence the body 414 is shaped such that about 90 degrees of the first magnetic flux pathway 302 is around the body 414, and the remaining 270 degrees of the first magnetic flux pathway 302 is around the track segment 402. This convention will be used throughout the present specification.

Furthermore, a first opposite end 412-1 is oriented such that the first opposite end 412-1 faces upwards, and a second opposite end 412-2 is oriented such that the second opposite end 412-2 faces leftwards (though left and right are understood to be relative to the page of FIG. 4A). Put another way, the first opposite end 412-1 is oriented such that the first opposite end 412-1 faces in the “Z” direction of the coordinate system 212, and the second opposite end 412-2 is oriented such that the second opposite end 412-2 faces in the “Y” direction of the coordinate system 212. Put yet another way, the opposite ends 412-1, 412-2 may form planes (e.g. and/or are portions of respective planes) that are about 90 degrees to each other.

As such, respective magnetic forces 416, 418 formed between an end 412 and an adjacent end of the track segment 402, do not cancel each other out, as with the forces 316 and/or the forces 318 in the configurations of FIG. 3A and FIG. 3C. For example, as depicted, the first opposite end 412-1 may have a NORTH (e.g. “N”) polarization, and a first adjacent end 420-1 of the track segment 402 has a SOUTH (e.g. “S”) polarization such that the force 416 is towards the track segment 402 in the “Z” direction of the coordinate system 212, and perpendicular to the propulsion force 310. It is further understood that as the track segment 402 is in a fixed position (e.g. affixed to the wall 102), the force 416 generally comprises a levitation force that vertically moves the propulsion motor 110 upwards towards the track segment 402. It is further understood that such a levitation force 416 may be balanced by gravitational pull on the propulsion motor 110 and/or a vehicle 112 to which the propulsion motor 110 are attached, such that the levitation force 416 assists at levitating the propulsion motor 110 relative to the track 104.

Similarly, as depicted, the second opposite end 412-2 may have a SOUTH (e.g. “S”) polarization, and a second adjacent end 420-2 of the track segment 402 has a NORTH (e.g. “N”) polarization such that the force 418 is towards the track segment 402 in the “Y” direction of the coordinate system 212, and perpendicular to the propulsion force 310. It is further understood that as the track segment 402 is in a fixed position (e.g. affixed to the wall 102), the force 418 generally comprises a guidance force that laterally moves the propulsion motor 110 towards the track segment 402. It is further understood that such a guidance force 418 may be balanced by a similar guidance force 418, in an opposite direction, provided by a similar propulsion motor 110 located at an opposite side of a vehicle 112 to which the propulsion motors 110 are attached, as described in more detail below.

It is further understood that the forces 416, 418 are normal to respective opposite ends 412 and that the forces 416, 418 are at about 90 degrees (e.g. perpendicular) relative to each other, and the propulsion force 310.

Put another way, the opposite ends 412 of the at least one ferromagnetic core 406 (e.g. of the propulsion motor 110) may be at about 90 degrees such that the at least one ferromagnetic core 406 forms: a first total force 416 normal to a first end 412-1, of the opposite ends 412; and a second total force 418 normal to a second end 412-2, of the opposite ends 412, the first total force 416 and the second total force 418 being about 90 degrees relative to each other.

Furthermore, the forces 416, 418 may be referred to as respective “total” forces relative to a particular direction in which they are formed. For example, as there is only one force 416 along the “Z” axis of the coordinate system 212, the force 416 may be understood to comprise a total of the forces along the “Z” axis of the coordinate system 212 for a respective ferromagnetic core 406. Similarly, as there is only one force 418 along the “Y” axis of the coordinate system 212, the force 418 may be understood to comprise a total of the forces along the “Y” axis of the coordinate system 212 for a respective ferromagnetic core 406.

The ends 420-1, 420-2 (e.g. opposite ends 420 and/or ends 420, and/or an opposite end 420 and/or an end 420) of the track segment 402 are understood to comprise respective opposite ends of the track segment 402, joined by a respective body 422.

As depicted, a shape of the track segment 402 is understood to be complementary to the ferromagnetic core 406, such that the first magnetic pathway 302 may form a closed loop and/or pathway around the track segment 402 and the ferromagnetic core 406. Hence, as the body 414 has an “L” shape and/or form about 25% and/or 90 degrees of the first magnetic pathway 302, the body 422 is understood to form the remaining 75% and/or 270 degrees of the first magnetic pathway 302.

Attention is next directed to FIG. 4B and FIG. 4C which respectively depict a perspective and side views of the track 104 and the propulsion motor 110 adapted to include the track segments 402, the ferromagnetic cores 406, the magnetic flux inducing devices 408 (e.g. field coils) and the armature coils 410, which are seen to have a 90 degree shape. FIG. 4B and FIG. 4C also better shows the orientation of the components as arranged into the track 104 and the propulsion motor 110, as well as the perpendicular orientation of the forces 310, 416, 418 relative to each other and along respective axes “X”, “Z” and “Y” of the coordinate system 212. FIG. 4B and FIG. 4C further depict one example of each of the forces 416, 418, though it is understood that a respective force 416, 418 is generated at each of the ferromagnetic cores 406 when adjacent a track segment 402. Hence, the sum of the levitation forces 416 assist with levitating the propulsion motor 110 against gravity. Similarly, the sum of the guidance forces 418 assist with guiding the propulsion motor 110 towards the track 104, for example, in combination with at least a second propulsion motor 110 interacting with a second portion of the track 104 at an opposite side of a vehicle 112 to which the propulsion motors 110 are attached, as described in more detail below.

Hereafter, different configurations (e.g. topologies) of the propulsion motor 110 and the track 104 will be described showing different geometries of respective ferromagnetic cores and track segments. While the magnetic flux pathways 302, 306 and/or magnetic flux 304, 308 are depicted, they are nonetheless understood to be present to provide the propulsion force 310.

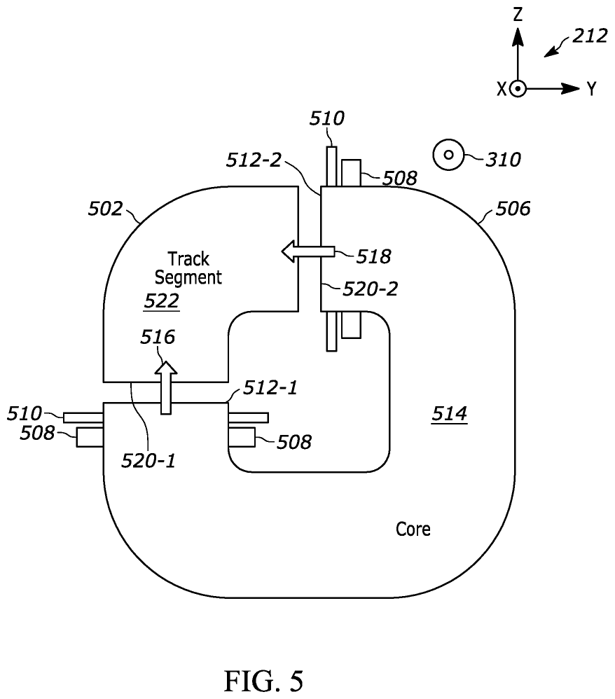

Attention is next directed to FIG. 5 which depicts another example configuration of a track segment 502 of the track 104, and a ferromagnetic core 506, one or more magnetic flux inducing devices 508 (e.g. field coils) and armature coils 510, of the propulsion motor 110. In these examples, the ferromagnetic core 506 comprises opposite ends 512-1, 512-2 (e.g. opposite ends 512 and/or an opposite end 512) joined by a body 514 that has a 270 degree shape (e.g. covering 75% and/or 270 degrees of the first magnetic flux pathway 302), similar to the shape of the body 422 of the track segment 402. Furthermore, a first opposite end 512-1 is facing upwards along the “Z” axis of coordinate system 212, and a second opposite end 512-2 is facing leftwards along the “Y” axis of coordinate system 212, but arranged so that the second opposite end 512-2 is higher, relative to the ground (e.g. the Earth) than the first opposite end 512-1. Put yet another way, the opposite ends 512-1, 512-2 may form planes (e.g. and/or are portions of respective planes) that are about 90 degrees to each other.

As such, a levitating force 516 is normal to the first opposite end 512-1, and a guidance force 518 is normal to the second opposite end 512-2. Further the track segment 502 is of a complementary 90 degree shape (e.g. covering 25% and/or 90 degrees of the first magnetic flux pathway 302) to the ferromagnetic core 506, having opposite ends 520-1, 520-2, separated by a respective body 522, facing respective opposite ends 512-1, 512-2 of the track segment 502.

Furthermore, the forces 310, 516, 518 are understood to all be at 90 degrees and/or perpendicular to one another.

While the configurations depicted in FIG. 4A and FIG. 5 includes both a levitation force (e.g. forces 416, 516) and a guidance force (e.g. forces 418, 518) being generated perpendicular to each other, in other configurations, a shape of a ferromagnetic core and/or an orientation thereof with respect to a respective track segment, may result in a levitation force but no guidance force, or a guidance force but no levitation force.

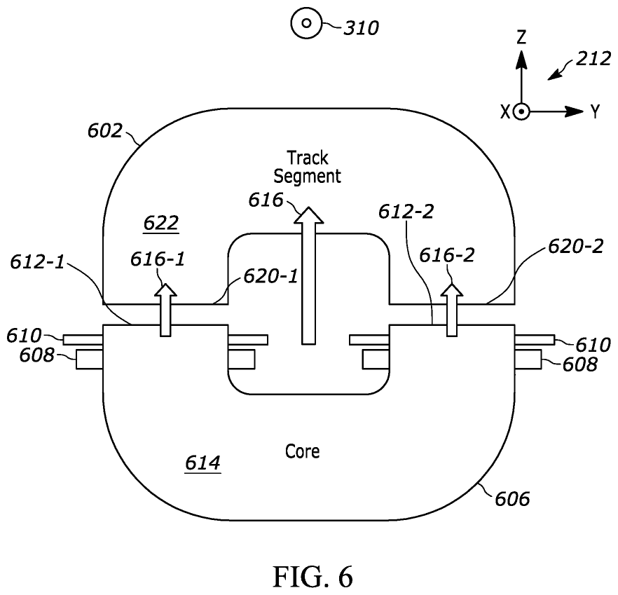

Attention is next directed to FIG. 6 which depicts another example configuration of a track segment 602 of the track 104, and a ferromagnetic core 606, one or more magnetic flux inducing devices 608 (e.g. field coils) and armature coils 610, of the propulsion motor 110. In these examples, the ferromagnetic core 606 comprises opposite ends 612-1, 612-2 (e.g. opposite ends 612 and/or an opposite end 612) joined by a body 614 that has a 180 degree shape (e.g. 50% and/or 180 degrees of the first magnetic flux pathway 302). Furthermore, a first opposite end 612-1 is facing upwards along the “Z” axis of coordinate system 212, and a second opposite end 612-2 is also facing upwards along the “Z” axis of coordinate system 212. In particular, as depicted, the opposite ends 612 are in a same plane. As each opposite end 612 is facing upwards, a respective levitating force 616-1, 616-2 is formed and/or generated at each opposite end 612, normal to a respective opposite end 612. However, as neither opposite end 612 is facing along the “Y” axis of coordinate system 212, no guidance force is generated. Hence, the respective levitating forces 616-1, 616-2 form a total force 616 perpendicular to the propulsion force 310, that assists at levitating the propulsion motor 110 and/or the vehicle 112. Furthermore, the levitating forces 616-1, 616-2 are about parallel to each other.

Further the track segment 602 is of a complementary 180 degree shape (e.g. 50% and/or 180 degrees of the first magnetic flux pathway 302) to the ferromagnetic core 606, having opposite ends 620-1, 620-2, separated by a respective body 622, facing respective opposite ends 612-1, 612-2 of the track segment 602.

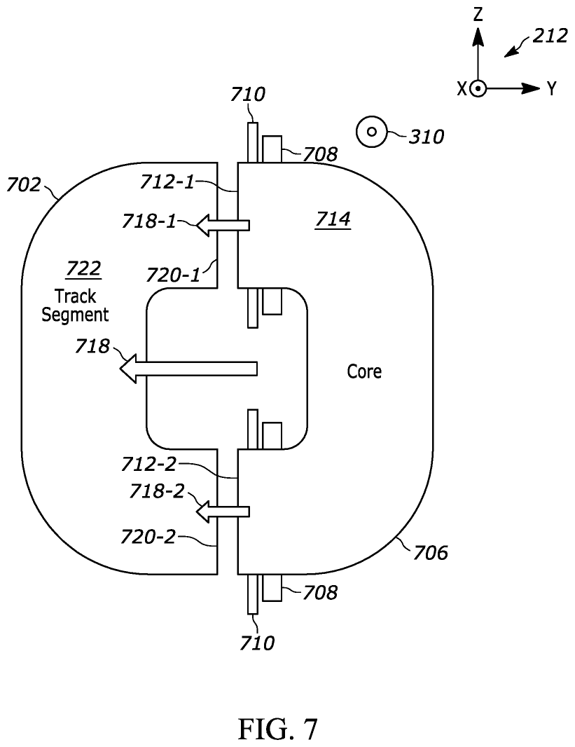

Attention is next directed to FIG. 7 which depicts another example configuration of a track segment 702 of the track 104, and a ferromagnetic core 706, one or more magnetic flux inducing devices 708 (e.g. field coils) and armature coils 710, of the propulsion motor 110. In these examples, the ferromagnetic core 706 comprises opposite ends 712-1, 712-2 (e.g. opposite ends 712 and/or an opposite end 712) joined by a body 714 that has a 180 degree shape (e.g. 50% and/or 180 degrees of the first magnetic flux pathway 302), but rotated by 90 degrees relative to the configuration of FIG. 6. Similarly, the track segment 702 is rotated by 90 degrees relative to the configuration of FIG. 6.

Hence, a first opposite end 712-1 is facing leftwards and/or in a direction along the “Y” axis of coordinate system 212, and a second opposite end 712-2 is facing leftwards and/or in a same direction along the “Y” axis of coordinate system 212. In particular, as depicted, the opposite ends 712 are in a same plane. As each opposite end 712 is facing in a same direction along the “Y” axis of coordinate system 212, a respective guidance force 718-1, 718-2 is formed and/or generated at each opposite end 712, normal to a respective opposite end 712. However, as neither opposite end 712 is facing along the “Z” axis of coordinate system 212, no levitation force is generated. Hence, the respective guidance forces 718-1, 718-2 form a total force 718 perpendicular to the propulsion force 310, that assists at laterally guiding the propulsion motor 110 and/or the vehicle 112. Furthermore, the guidance forces 718 are about parallel to each other.

Further the track segment 702 is of a complementary 180 degree shape (e.g. 50% and/or 180 degrees of the first magnetic flux pathway 302) to the ferromagnetic core 706, having opposite ends 720-1, 720-2, separated by a respective body 722, facing respective opposite ends 712-1, 712-2 of the track segment 702.

While the configuration of FIG. 7 is depicted in a “right” configuration, such that the ferromagnetic core 706 is to the right of the track segment 702 (e.g. in a plane of the page of FIG. 7) and the guidance forces 718 are to the left, the configuration of FIG. 7 may be rotated by 180 degrees to a “left” configuration, such that the ferromagnetic core 706 is to the left of the track segment 702, and the guidance forces 718 are in an opposite direction, to the right.

Hence, with regards to the configuration of FIG. 6 and/or FIG. 7, it is understood that a body between the opposite ends (e.g. ends 612 or ends 712) of a ferromagnetic core (e.g. a ferromagnetic core 606 or a ferromagnetic core 706) may have an about 180 degrees shape (e.g. such that the opposite ends are in a same plane) such that the ferromagnetic core forms: a first total force (e.g. a first force 616 or a first force 718) normal to a first end, of the opposite ends; and a second total force (e.g. a second force 616 or a second force 718) normal to a second end, of the opposite ends, the first total force and the second total force about parallel relative to each other. Whether the forces formed by a 180 degree ferromagnetic core are levitating forces or guidance forces (e.g. in addition to a propulsion force) generally depends on the orientation of the ferromagnetic core relative to the ground and/or the Earth.

While examples of opposite ends of ferromagnetic cores that are in same planes and/or are at 90 degrees to each other have been heretofore described, with bodies of the ferromagnetic cores covering 90 to 270 degrees of a magnetic flux pathway, in other examples ferromagnetic cores may be in other configurations, with track segments adapted accordingly.

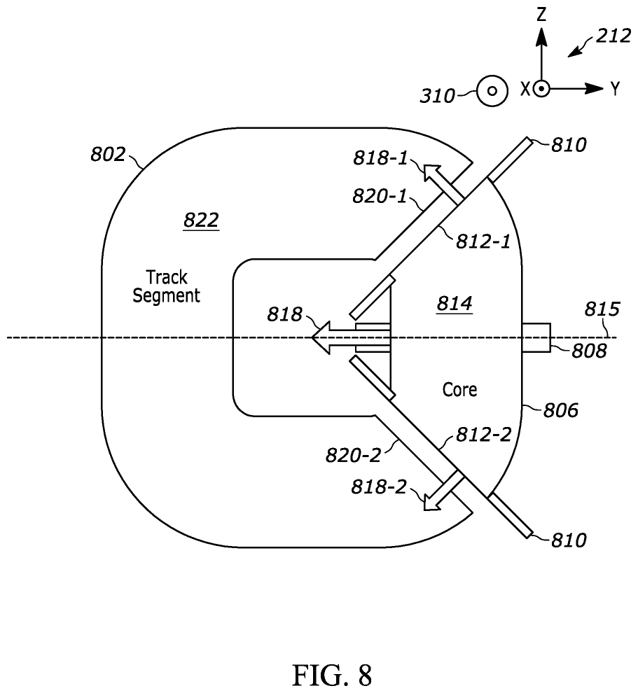

For example, attention is next directed to FIG. 8 which depicts another example configuration of a track segment 802 of the track 104, and a ferromagnetic core 806, a magnetic flux inducing device 808 (e.g. a field coil) and armature coils 810, of the propulsion motor 110.

In these examples, the ferromagnetic core 806 comprises opposite ends 812-1, 812-2 (e.g. opposite ends 812 and/or an opposite end 812) joined by a body 814 that covers about 25% and/or about 90 degrees of the first magnetic flux pathway 302.

To better describe the configuration of the opposite ends 812 and the body 814, a center plane 815 of the ferromagnetic core 806 is also depicted (e.g. viewed from a side thereof), the center plane 815 extending along the “XY” axes of the coordinate system 212 (e.g. with the “Z” axis of the coordinate system 212 being normal to the center plane 815), and bisecting the ferromagnetic core 806 and the track segment 802. In particular, as depicted, each of the opposite ends 812 is at about a 45 degree angle to the center plane 815, but generally facing away from each other.

Hence, a first opposite end 812-1 is facing 45 degrees upwards and leftwards, relative to the center plane 815, and a second opposite end 812-2 is facing 45 degrees downwards and leftwards, relative to the center plane 815. As such, the opposite ends 812 are symmetrical mirror-images of each other. Hence, a respective force 818-1, 818-2 is formed and/or generated at each opposite end 812, normal to a respective opposite end 812, with the forces 818-1, 818-2 each forming a respective 45 degree angle with both the “Y” axis of the coordinate system 212 and the “Z” axis of the coordinate system 212. As such, the forces 818-1, 818-2 are understood to have respective components in the “Y” axis of the coordinate system 212 and the “Z” axis of the coordinate system 212.

In these examples, due to the more limited space available relative to the configurations of FIG. 5, FIG. 6 and FIG. 7, only one magnetic flux inducing device 808 (e.g. one field coil) is provided, for example located at about the center plane 815.

As apparent from FIG. 8, as both opposite ends 812 are at a same respective angle to the center plane 815, but as the first opposite end 812-1 is angled upwards and the second opposite end 812-2 is angled downwards, components of the forces 818-1, 818-2 along the “Z” axis of the coordinate system 212 may be equal in magnitude, but opposite in direction, such that they cancel each other out (e.g. similar to the forces 316 and/or the forces 318 of the configuration of FIG. 3A and FIG. 3C); as such, no total levitation force is formed by the forces 818-1, 818-2.

However, in contrast, as both opposite ends 812 are at a same respective angle to the center plane 815, but as both the opposite ends 812-1 are angled leftward (e.g. in a same lateral direction relative to the “Y” axis of the coordinate system 212), components of the forces 818-1, 818-2 along the “Y” axis of the coordinate system 212 may be equal in magnitude, and in a same direction, such that they add to a total guidance force 818 towards the track segment 802.

Further the track segment 802 is of a complementary 75% and/or 270 degree shape (e.g. 75% and/or 270 degrees of the first magnetic flux pathway 302) to the ferromagnetic core 806, having opposite ends 820-1, 820-2, separated by a respective body 822, facing respective opposite ends 812-1, 812-2 of the track segment 802.

While the configuration of FIG. 8 is depicted in a “right” configuration, such that the ferromagnetic core 806 is to the right of the track segment 802 (e.g. in a plane of the page of FIG. 8) and the total guidance force 818 is to the left, the configuration of FIG. 8 may be rotated by 180 degrees to a “left” configuration, such that the ferromagnetic core 806 is to the left of the track segment 802, and the total guidance force 818 is in an opposite direction, to the right.

Furthermore, as with the configurations of FIG. 4A and FIG. 5 the relative shapes of the track segments and the ferromagnetic cores may be interchanged.

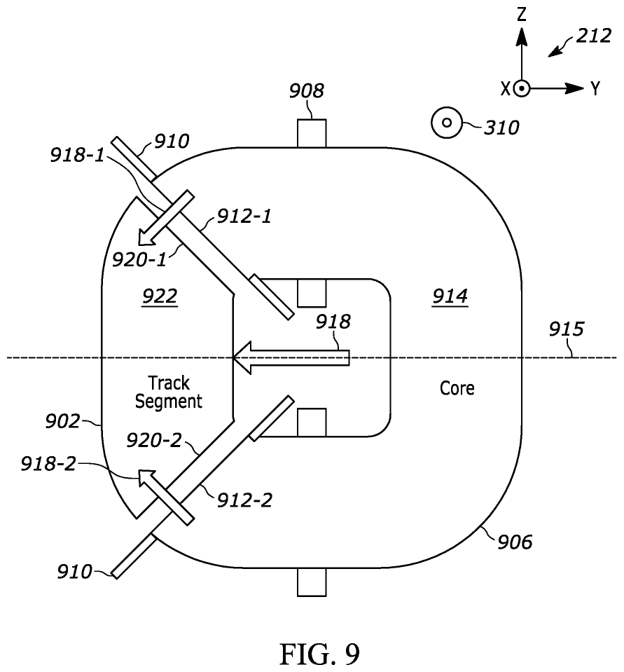

For example, attention is next directed to FIG. 9 which depicts another example configuration of a track segment 902 of the track 104, and a ferromagnetic core 906, a magnetic flux inducing device 908 (e.g. a field coil) and armature coils 910, of the propulsion motor 110.

In these examples, the ferromagnetic core 906 comprises opposite ends 912-1, 912-2 (e.g. opposite ends 912 and/or an opposite end 912) joined by a body 914 that covers about 75% and/or about 270 degrees of the first magnetic flux pathway 302.

To better describe the configuration of the opposite ends 912 and the body 914, a center plane 915 of the ferromagnetic core 906 is also depicted (e.g. viewed from a side thereof), the center plane 915 extending along the “XY” axes of the coordinate system 212 (e.g. with the “Z” axis of the coordinate system 212 being normal to the center plane 915), and bisecting the ferromagnetic core 906 and the track segment 902. In particular, as depicted, each of the opposite ends 912 is at about a 45 degree angle to the center plane 915, but generally facing towards each other.

Hence, a first opposite end 912-1 is facing 45 degrees downwards and leftwards, relative to the center plane 915, and a second opposite end 912-2 is facing 45 degrees upwards and leftwards, relative to the center plane 915. As such, the opposite ends 912 are symmetrical mirror-images of each other. Hence, a respective force 918-1, 918-2 is formed and/or generated at each opposite end 912, normal to a respective opposite end 912, with the forces 918-1, 918-2 each forming a respective 45 degree angle with both the “Y” axis of the coordinate system 212 and the “Z” axis of the coordinate system 212. As such, the forces 918-1, 918-2 are understood to have respective components in the “Y” axis of the coordinate system 212 and the “Z” axis of the coordinate system 212.

As apparent from FIG. 9, as both opposite ends 912 are at a same respective angle to the center plane 915, but as the first opposite end 912-1 is angled upwards and the second opposite end 912-2 is angled downwards, components of the forces 918-1, 918-2 along the “Z” axis of the coordinate system 212 may be equal in magnitude, but opposite in direction, such that they cancel each other out (e.g. similar to the forces 316 and/or the forces 318 of the configuration of FIG. 3A and FIG. 3C); as such, no total levitation force is formed by the forces 918-1, 918-2.

However, in contrast, as both opposite ends 912 are at a same respective angle to the center plane 915, but as both the opposite ends 912-1 are angled leftward (e.g. in a same lateral direction relative to the “Y” axis of the coordinate system 212), components of the forces 918-1, 918-2 along the “Y” axis of the coordinate system 212 may be equal in magnitude, and in a same direction, such that they add to a total guidance force 918 towards the track segment 902.

Further the track segment 902 is of a complementary 90 degree shape (e.g. 25% and/or 90 degrees of the first magnetic flux pathway 302) to the ferromagnetic core 906, having opposite ends 920-1, 920-2, separated by a respective body 922, facing respective opposite ends 912-1, 912-2 of the track segment 902.

While the configuration of FIG. 9 is depicted in a “right” configuration, such that the ferromagnetic core 906 is to the right of the track segment 902 (e.g. in a plane of the page of FIG. 9) and the total guidance force 918 is to the left, the configuration of FIG. 9 may be rotated by 180 degrees to a “left” configuration, such that the ferromagnetic core 906 is to the left of the track segment 902, and the total guidance force 918 is in an opposite direction, to the right.

It is further understood that the configurations depicted in FIG. 8 and FIG. 9 may be rotated by 90 degrees to provide a levitation force rather than a guidance force.

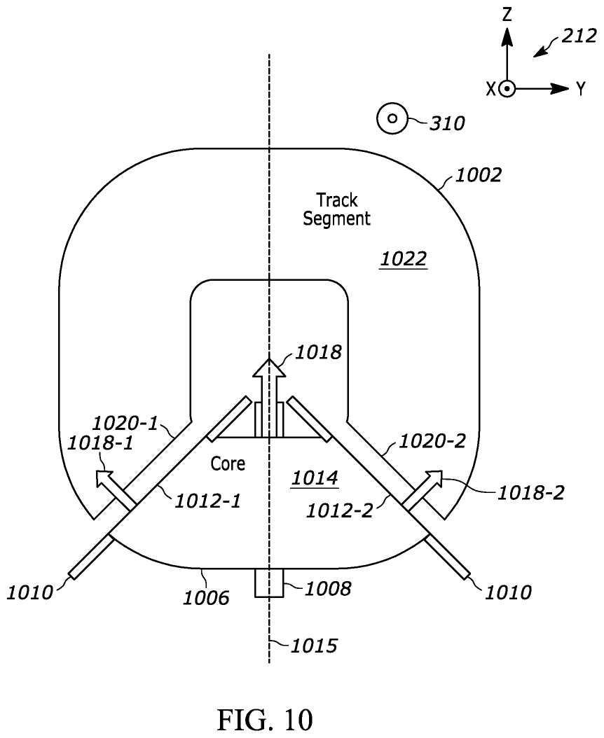

For example, attention is next directed to FIG. 10 which depicts another example configuration of a track segment 1002 of the track 104, and a ferromagnetic core 1006, a magnetic flux inducing device 1008 (e.g. a field coil) and armature coils 1010, of the propulsion motor 110. The configuration of FIG. 10 is hence similar to the configuration of FIG. 8, but rotated 90 degrees such that the track segment 1002 and/or the track 104 is above the ferromagnetic core 1006 and/or the propulsion motor 110.

In these examples, the ferromagnetic core 1006 comprises opposite ends 1012-1, 1012-2 (e.g. opposite ends 1012 and/or an opposite end 1012) joined by a body 1014 that covers about 90 degrees and/or 25% of the first magnetic flux pathway 302, similar to the configuration depicted in FIG. 8. To better describe the configuration of the opposite ends 1012 and the body 1014, a center plane 1015 of the ferromagnetic core 1006 is also depicted (e.g. viewed from a side thereof), the center plane 1015 extending along the “XZ” axes of the coordinate system 212 (e.g. with the “Y” axis of the coordinate system 212 being normal to the center plane 1015), and bisecting the ferromagnetic core 1006 and the track segment 1002. In particular, as depicted, each of the opposite ends 1012 is at about a 45 degree angle to the center plane 1015, but generally facing away from each other.

Hence, a first opposite end 1012-1 is facing 45 degrees upwards and leftwards, relative to the center plane 1015, and a second opposite end 1012-2 is facing 45 degrees upwards and rightwards, relative to the center plane 1015. As such, the opposite ends 1012 are symmetrical mirror-images of each other. Hence, a respective force 1018-1, 1018-2 is formed and/or generated at each opposite end 1012, normal to a respective opposite end 1012, with the forces 1018-1, 1018-2 each forming a respective 45 degree angle with both the “Y” axis of the coordinate system 212 and the “Z” axis of the coordinate system 212. As such, the forces 1018-1, 1018-2 are understood to have respective components in the “Y” axis of the coordinate system 212 and the “Z” axis of the coordinate system 212.

As apparent from FIG. 10, as both opposite ends 1012 are at a same respective angle to the center plane 1015, but as both the opposite ends 1012-1 are angled upward (e.g. in a same upward direction relative to the “Z” axis of the coordinate system 212), components of the forces 1018-1, 1018-2 along the “Z” axis of the coordinate system 212 may be equal in magnitude, and in a same direction, such that they add to a total levitation force 1018 towards the track segment 1002

However, in contrast, as both opposite ends 1012 are at a same respective angle to the center plane 1015, but as the first opposite end 1012-1 is angled leftwards and the second opposite end 1012-2 is angled rightwards, components of the forces 1018-1, 1018-2 along the “Y” axis of the coordinate system 212 may be equal in magnitude, but opposite in direction, such that they cancel each other out (e.g. similar to the forces 316 and/or the forces 318 of the configurations of FIG. 3A and FIG. 3C); as such, no total guidance force is formed by the forces 1018-1, 1018-2.

Further the track segment 1002 is of a complementary 270 degree shape to the ferromagnetic core 1006, having opposite ends 1020-1, 1020-2, separated by a respective body 1022, facing respective opposite ends 1012-1, 1012-2 of the track segment 1002.

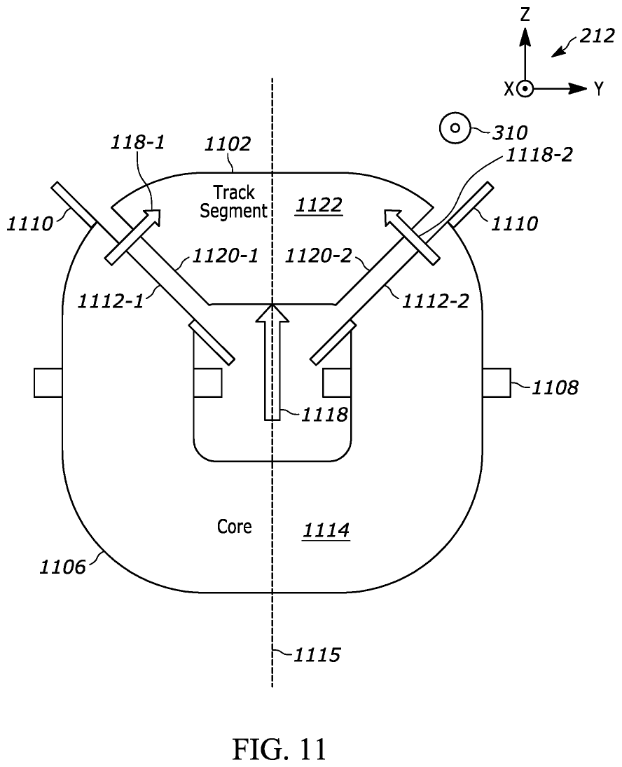

Similarly, attention is directed to FIG. 11, which depicts another example configuration of a track segment 1102 of the track 104, and a ferromagnetic core 1106, a magnetic flux inducing device 1108 (e.g. a field coil) and armature coils 1110, of the propulsion motor 110.

In these examples, similar to the example of FIG. 9, the ferromagnetic core 1106 comprises opposite ends 1112-1, 1112-2 (e.g. opposite ends 1112 and/or an opposite end 1112) joined by a body 1114 that covers about 75% and/or 270 degrees of the first magnetic flux pathway 302. The configuration of FIG. 11 is hence similar to the configuration of FIG. 9, but rotated 90 degrees such that the track segment 1102 and/or the track 104 is above the ferromagnetic core 1106 and/or the propulsion motor 110.

To better describe the configuration of the opposite ends 1112 and the body 1114, a center plane 1115 of the ferromagnetic core 1106 is also depicted (e.g. viewed from a side thereof), the center plane 1115 extending along the “XZ” axes of the coordinate system 212 (e.g. with the “Y axis of the coordinate system 212 being normal to the center plane 1115), and bisecting the ferromagnetic core 1106 and the track segment 1102. In particular, as depicted, each of the opposite ends 1112 is at about a 45 degree angle to the center plane 1115, but generally facing towards each other.

Hence, a first opposite end 1112-1 is facing 45 degrees upwards and rightwards, relative to the center plane 1115, and a second opposite end 1112-2 is facing 45 degrees upwards and leftwards, relative to the center plane 1115. As such, the opposite ends 1112 are symmetrical mirror-images of each other. Hence, a respective force 1118-1, 1118-2 is formed and/or generated at each opposite end 1112, normal to a respective opposite end 1112, with the forces 1118-1, 1118-2 each forming a respective 45 degree angle with both the “Y” axis of the coordinate system 212 and the “Z” axis of the coordinate system 212. As such, the forces 1118-1, 1118-2 are understood to have respective components in the “Y” axis of the coordinate system 212 and the “Z” axis of the coordinate system 212.

As apparent from FIG. 11, as both opposite ends 1112 are at a same respective angle to the center plane 1115, but as both the opposite ends 1112-1 are angled upward (e.g. in a same lateral direction relative to the “Z” axis of the coordinate system 212), components of the forces 1118-1, 1118-2 along the “Z” axis of the coordinate system 212 may be equal in magnitude, and in a same direction, such that they add to a total levitation force 1118 towards the track segment 1102.

In contrast, as both opposite ends 1112 are at a same respective angle to the center plane 1115, but as the first opposite end 1112-1 is angled rightwards and the second opposite end 1112-2 is angled leftwards, components of the forces 1118-1, 1118-2 along the “Y” axis of the coordinate system 212 may be equal in magnitude, but opposite in direction, such that they cancel each other out (e.g. similar to the forces 316 and/or the forces 318 of the configurations of FIG. 3A and FIG. 3C); as such, no total guidance force is formed by the forces 1118-1, 1118-2.

Further the track segment 1102 is of a complementary 270 degree shape to the ferromagnetic core 1106, having opposite ends 1120-1, 1120-2, separated by a respective body 1122, facing respective opposite ends 1112-1, 1112-2 of the track segment 1102.

It is further understood that while the configurations of FIG. 8, FIG. 9, FIG. 10 and FIG. 11 have been described with respect to the opposite ends having an angle of 45 degrees with a center (bisecting) plane, any suitable given angle is within the scope of the present specification. In particular, opposite ends of the ferromagnetic core may form a non-zero angle relative to each other and/or a center (bisecting) plane, the opposite ends forming symmetrical mirror-images of each other.

Indeed, put another way, in some examples, opposite ends of at least one ferromagnetic core may be at a given angle relative to a center (e.g. bisecting) plane of the at least one ferromagnetic core, such that the at least one ferromagnetic core forms: a first force normal to a first end, of the opposite ends; and a second force normal to a second end, of the opposite ends, the first force and the second force summing together to form the one or more total forces perpendicular to the propulsion force; in some of these examples, the given angle is selected such that first components of the first force and the second force, perpendicular to the propulsion force 310, cancel out, and second components of the first force and the second force, perpendicular to the propulsion force 310, add and/or sum to form a total force perpendicular to the propulsion force 310. Furthermore, such a given angle may be greater than 0 degrees and less than 180 degrees.

Put yet another way, opposite ends of the at least one ferromagnetic core as provided herein may be portions of respective intersecting planes that intersect at an angle that is between 0 degrees and less than 180 degrees. Indeed, any of the configurations of FIG. 3A, FIG. 3C, FIG. 4A, FIG. 5, FIG. 6 and FIG. 7 may be adapted according to the configurations of FIG. 8, FIG. 9, FIG. 10 and FIG. 11.

Alternatively, when the given angle is 180 degrees (e.g. as in FIG. 6 or FIG. 7), the forces normal to the opposite ends may already be perpendicular to the propulsion force 310 with no perpendicular components in other directions.

Furthermore, while configurations of FIG. 3A, FIG. 4A, FIG. 5, FIG. 6 and FIG. 7, FIG. 8, FIG. 9, FIG. 10 and FIG. 11 have been described with respect to magnetic flux inducing devices thereof comprising one or more field coils, such magnetic flux inducing devices may be replaced with one or more magnets as in the configuration of FIG. 3B, and/or such magnetic flux inducing devices may comprise any suitable combination of one or more field coils and/or one or more magnets.

Other alternative configurations and/or topologies of the propulsion motor 110 and the track 104 are within the scope of the present specification.

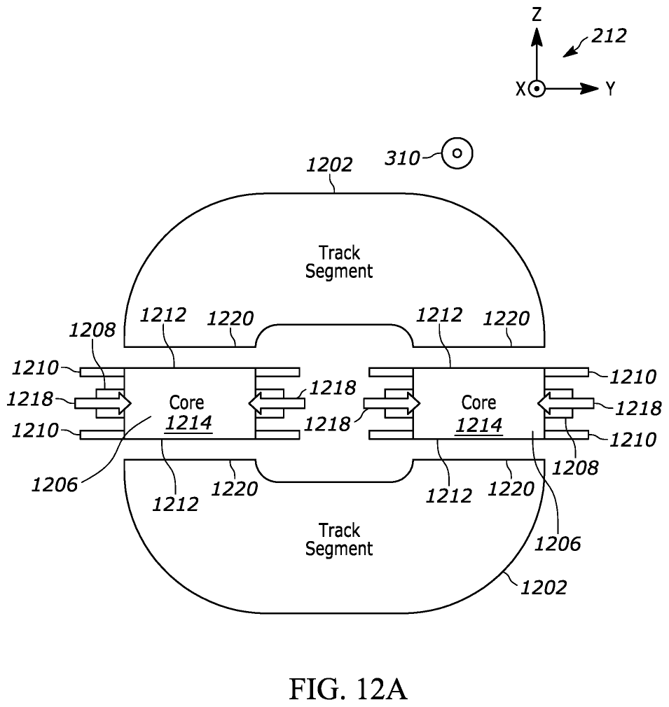

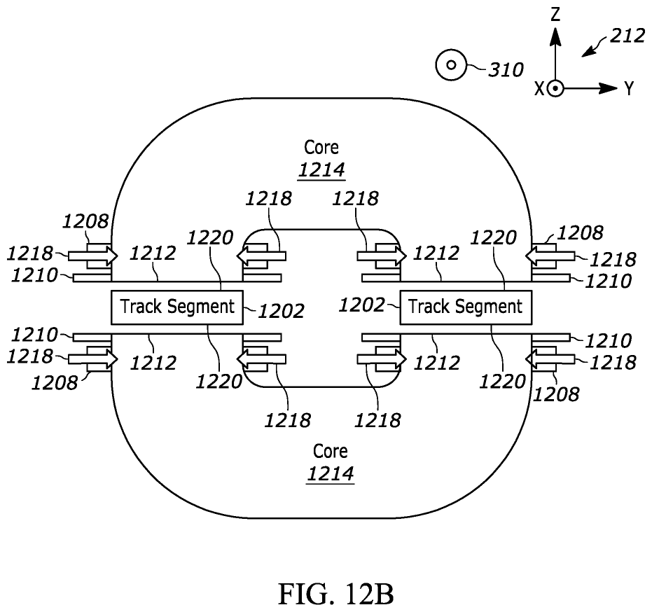

For example, attention is next directed to FIG. 12A and FIG. 12B which depict two further configurations and/or topologies of a track segment of the track 104, and ferromagnetic cores, etc., of the propulsion motor 110.

Attention is next directed to FIG. 12A which depict a configuration comprising a pair of track segments 1202 having a 180 degree configuration and/or U-shaped, similar to as depicted in FIG. 6, respective ends of the track segments 1202 facing each other, as described in more detail below.

The configuration of FIG. 12A further includes ferromagnetic cores 1206 arranged in pairs (e.g. one pair of ferromagnetic cores 1206 is depicted), magnetic flux inducing devices 1208 (e.g. respective field coils, one of each of the ferromagnetic cores 1206 of a pair), and armature coils 1210, 1210 (e.g. as depicted, a set of armature coils for each of the ferromagnetic cores 1206 of a pair). Hence, in general, the configuration of FIG. 12A is similar to the configuration of FIG. 3A, but with ferromagnetic cores 1206 arranged in pairs and the track segments 1202 adapted accordingly.

In particular, the ferromagnetic cores 1206 have respective opposite ends 1212 joined by a respective body 1214 forming a first magnetic flux pathway (e.g. the magnetic flux pathway 302) between the respective opposite ends 1212, for example, in combination with the track segments 1202.

The magnetic flux inducing devices 1208 are to induce first magnetic flux (e.g. the magnetic flux 304) in the ferromagnetic cores 1206 along the magnetic flux pathway. While as depicted, the magnetic flux inducing devices 1208 comprise field coils, the magnetic flux inducing devices 1208 may comprise magnets in addition to field coils or in place of field coils.

The armature coils 1210 induce respective varying second magnetic flux (e.g. the second magnetic flux 308 along the second magnetic flux pathway 306) in the ferromagnetic cores 1206 perpendicular to the magnetic flux pathway, to assist inducing the propulsion force 310 perpendicular to the magnetic flux pathway. In these examples, it is understood that a second magnetic flux pathway 306 and a second magnetic flux 308 are induced at both of the ferromagnetic cores 1206 of a pair.

In general, the ferromagnetic cores 1206 are arranged in pairs, such that a pair of the ferromagnetic cores 1206 comprises: a first ferromagnetic core 1206 comprising first opposite ends 1212 (e.g. the ferromagnetic core 1206 at the left side of FIG. 12A, or vice versa); and a second ferromagnetic core 1206 comprising second opposite ends 1212 (e.g. the ferromagnetic core 1206 at the right side of FIG. 12A, or vice versa).

Furthermore, the first opposite ends 1212, and the second opposite ends 1212, are understood to be about respectively parallel to each other, and are respectively configured to interact with respective ends 1220 of the track segment 1202 of the track 104 that completes, in combination with the first ferromagnetic core 1206 and the second ferromagnetic core 1206, the first magnetic flux pathway 302. Put another way, each set of opposite ends 1212 of a given ferromagnetic core 1206 are understood to be about parallel to each other, and facing in opposite directions, for example along the “Z” axis of the coordinate system 212. Put yet another way, each set of opposite ends 1212 of a given ferromagnetic core 1206 are between respective ends 1220 of a pair of track segments 1202.

As such, two respective forces 1218 are formed, for example one set of respective forces 1218 for each ferromagnetic core 1206, the two respective forces 1218 perpendicular to the first opposite ends 1212 and the second opposite ends 1212, and perpendicular to the propulsion force 310. The two respective forces 1218 are understood to be similar to the forces 318 of the configurations of FIG. 3A and FIG. 3C. The two respective forces 1218 are understood to be of a same order of magnitude, but opposite in direction, such that a total force on the first opposite ends 1212 and the second opposite ends 1212, due to the two respective forces 1218, may be about zero, or close to zero when the respective ends 1212 of the respective ferromagnetic cores 1206 are centered relative to respective ends 1220 of the track segments 1202. Put another way, the forces 1218 act as centering forces which center respective ends 1212 of the respective ferromagnetic cores 1206 relative to respective ends 1220 of the track segments 1202, along the “Y” axis of the coordinate system 212. Furthermore, it is understood that if the opposite ends 1212 of the ferromagnetic cores 1206 drift out of center with respective ends 1220 of the track segments 1202, the pairs of forces 1218 will change accordingly to move the opposite ends 1212 of the ferromagnetic cores 1206 back towards the center of the respective ends 1220 of the track segments 1202. Hence, in comparison to the configurations of FIG. 3A and FIG. 3C, the centering forces (e.g. guidance forces) 1218 are doubled.

Attention is next directed to FIG. 12B which is similar to the configuration of FIG. 12A, with like components having like numbers. However, in the configuration of FIG. 12B, the shapes of the track segments 1202 and the ferromagnetic cores 1206 are interchanged, such that the ferromagnetic cores 1206 have a body 1214 that is 180 degree and/or U-shaped, with respective ends 1212 facing each other, with respective track segments 1202 between a pair of respective ends 1212. Hence, opposing centering and/or guidance forces 1218 are formed at each of the respective ends 1212, similar to as in the configuration of FIG. 12A.

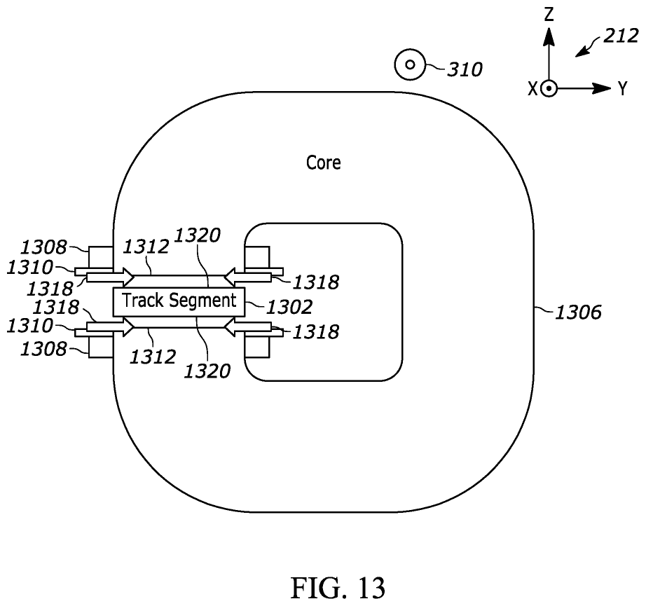

Attention is next directed to FIG. 13 which depicts yet another configuration of a track segment 1302 of the track 104 and a ferromagnetic core 1306, magnetic field inducing devices 1308 and armature coils 1310 of the propulsion motor 110. In these examples, the ferromagnetic core 1306 has an almost 360 degree configuration, with opposite ends 1312 facing each other (e.g. in the “Z” axis of the coordinate system 212, and being about parallel to each other, rather than at the 45 degree configuration as in FIG. 9) and adjacent respective ends 1320 of the track segment 1302. Hence, opposing centering and/or forces 1318 are formed at each of the respective ends 1212.

The vehicle 112 may be adapted to include any suitable number of propulsion motors 110 according to any suitable number of configurations and/or topologies as described herein, with the track 104 adapted accordingly.

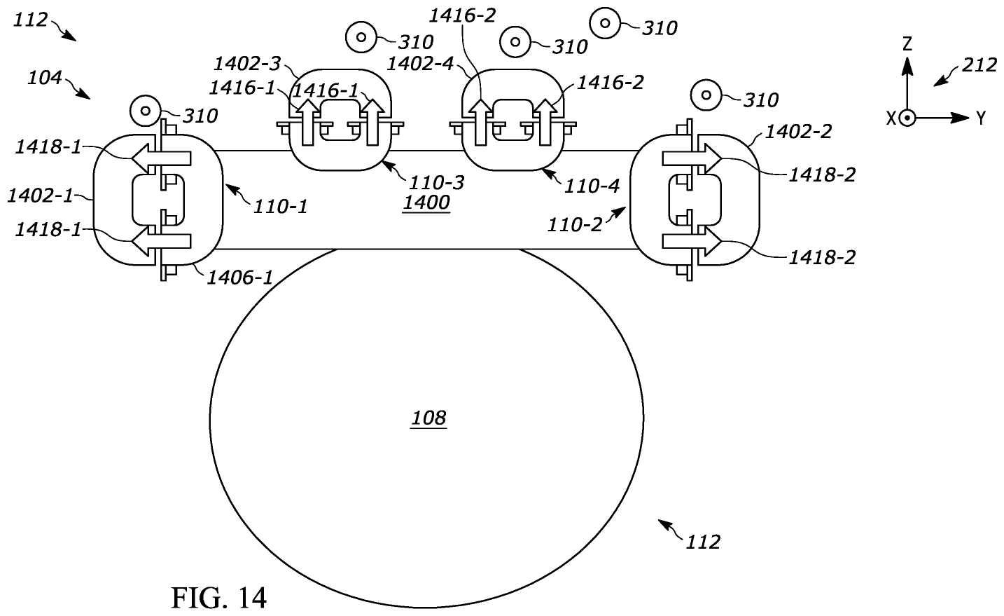

For example, attention is next directed to FIG. 14 which depicts a schematic end view of an example configuration of the vehicle 112 comprising the payload 108 and a structure 1400 to which respective propulsion motors 110-1, 110-2, 110-3, 110-4 (e.g. propulsion motors 110 and/or a propulsion motor 110) are attached. The structure 1400 may be colloquially referred to as a bogie, and is attached to the payload 108. Also depicted are respective track segments 1402-1, 1402-2, 1402-3, 1402-4 (e.g. track segments 1402 and/or a track segment 1402) which form respective portions of the track 104. Indeed, as shown by the coordinate system 212, the view of the vehicle 112 and the track 104 is along the direction of the “X” axis of the coordinate system 212. Hence, it is understood that the track 104 comprises respective sections that are formed from a plurality of each of the track segments 1402 (e.g. in and out of the page of FIG. 14).

As depicted, each propulsion motor 110 forms a respective propulsion force 310 in combination with respective track segments 1402. Furthermore, as depicted, the propulsion motors 110-3, 110-4 form respective levitation forces 1416-1, 1416-2 (e.g. levitation forces 1416 and/or a levitation force 1416), and the propulsion motors 110-1, 110-2 form respective guidance forces 1418-1, 1418-2 (e.g. guidance forces 1418 and/or a guidance force 1418), the forces 1416, 1418 perpendicular to each other, and respectively perpendicular to the propulsion forces 310.

Furthermore, while details of the propulsion motors 110 are not indicated, it is apparent that the propulsion motors 110-1, 110-2 comprise respective ferromagnetic cores, magnetic flux inducing devices and armature coils, etc., according to the configuration of FIG. 7, but attached to opposing sides of the structure 1400 along the “Y” axis of the coordinate system 212. Hence, the propulsion motors 110-1, 110-2 are in “left” and “right” configurations, respectively, and the respective guidance forces 1418-1, 1418-2 oppose each other along the “Y” axis of the coordinate system 212. When the respective guidance forces 1418-1, 1418-2 are of equal magnitude, they about cancel each other out. However, current in respective armature coils and/or field coils of the propulsion motors 110-1, 110-2 may be controlled (e.g. by a control system of the vehicle) to control relative magnitude of the respective guidance forces 1418-1, 1418-2 to move or guide the vehicle 112 “left” or “right”, and/or in any suitable direction along the “Y” axis of the coordinate system 212.

Similarly, while details of the propulsion motors 110 are not indicated, it is apparent that the propulsion motors 110-3, 110-4 comprise respective ferromagnetic cores, magnetic flux inducing devices and armature coils, etc., according to the configuration of FIG. 6, but attached to a top side of the structure 1400 along the “Z” axis of the coordinate system 212. Hence, the respective levitation forces 1416-1, 1416-2 are parallel to each other along the “Z” axis of the coordinate system 212. Hence, current in respective armature coils and/or field coils of the propulsion motors 110-3, 110-4 may be controlled (e.g. by a control system of the vehicle) to control relative magnitude of the respective levitation forces 1416-1, 1416-2 to move the vehicle 112 “up” or “down”, and/or to rotate the vehicle 112 relative to the “X” axis of the coordinate system 212.

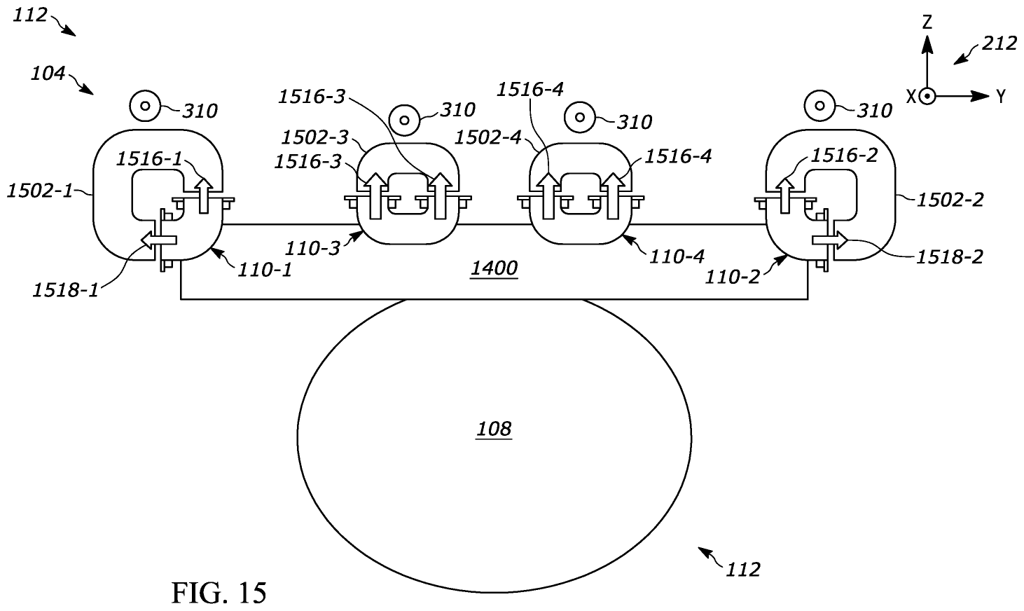

For example, attention is next directed to FIG. 15 which depicts a schematic view of another example configuration of the vehicle 112 comprising the payload 108 and the structure 1400 to which respective propulsion motors 110-1, 110-2, 110-3, 110-4 (e.g. propulsion motors 110 and/or a propulsion motor 110) are attached. Also depicted are respective track segments 1502-1, 1502-2, 1502-3, 1502-4 (e.g. track segments 1502 and/or a track segment 1502) which form respective portions of the track 104. Indeed, as shown by the coordinate system 212, the view of the vehicle 112 and the track 104 is along the direction of the “X” axis of the coordinate system 212. Hence, it is understood that the track 104 comprises respective sections that are formed from a plurality of each of the track segments 1502 (e.g. in and out of the page of FIG. 15).

As depicted, each propulsion motor 110 forms a respective propulsion force 310 in combination with respective track segments 1502. Furthermore, as depicted, the propulsion motors 110-1, 110-2, 110-3, 110-4 form respective levitation forces 1516-1, 1516-2, 1516-3, 1516-4 (e.g. levitation forces 1516 and/or a levitation force 1516), and the propulsion motors 110-1, 110-1 form respective guidance forces 1518-1, 1518-2 (e.g. guidance forces 1518 and/or a guidance force 1518), the forces 1516, 1518 perpendicular to each other, and respectively perpendicular to the propulsion forces 310.

Furthermore, while details of the propulsion motors 110 are not indicated, it is apparent that the propulsion motors 110-1, 110-2 comprise respective ferromagnetic cores, magnetic flux inducing devices and armature coils, etc., according to the configuration of FIG. 4, but attached to opposing sides of the structure 1400 along the “Y” axis of the coordinate system 212. Hence, the propulsion motors 110-1, 110-2 are in “left” and “right” configurations, respectively, and the respective guidance forces 1518-1, 1518-2 oppose each other along the “Y” axis of the coordinate system 212. When the respective guidance forces 1518-1, 1518-2 are of equal magnitude, they cancel each other out. However, current in respective armature coils and/or field coils of the propulsion motors 110-1, 110-2 may be controlled (e.g. by a control system of the vehicle) to control relative magnitude of the respective guidance forces 1518-1, 1518-2 to move or guide the vehicle 112 “left” or “right”, and/or in any suitable direction along the “Y” axis of the coordinate system 212.

However, as is apparent from FIG. 15 and FIG. 4, the propulsion motors 110-1, 110-2 also

form respective levitation forces 1516-1, 1516-2.

Similarly, while details of the propulsion motors 110 are not indicated, it is apparent that the propulsion motors 110-3, 110-4 comprise respective ferromagnetic cores, magnetic flux inducing devices and armature coils, etc., according to the configuration of FIG. 6, but attached to a top side of the structure 1400 along the “Z” axis of the coordinate system 212.

Hence, the respective levitation forces 1516-1, 1516-2, 1516-3, 1516-4 are parallel to each other along the “Z” axis of the coordinate system 212. Current in respective armature coils and/or field coils of the propulsion motors 110-1, 110-2 110-3, 110-4 may be controlled (e.g. by a control system of the vehicle) to control relative magnitude of the respective levitation forces 1516-1, 1516-2, 1516-3, 1516-4 to move the vehicle 112 “up” or “down”, and/or to rotate the vehicle 112 relative to the “X” axis of the coordinate system 212. In the example of FIG. 15, when the armature coils and/or field coils of the propulsion motors 110-1, 110-2 are controlled to control the respective guidance forces 1518-1, 1518-2, magnitude of respective levitation forces 1516-1, 1516-2 may change relative to each other which may result in rotation of the vehicle 112 in the “X” axis of the coordinate system 212, and such rotation may be mitigated and/or reduced by controlling the respective levitation forces 1516-3, 1516-4 to oppose such rotation.

It is further apparent from FIG. 15 that sizes of the propulsion motors 110 may vary to generate different magnitudes of respective forces 310, 1516, 1518.

Furthermore, it is further apparent from FIG. 14 and FIG. 15 that at least a portion of respective propulsion forces, levitation forces and guidance forces may be controlled independent of each other, to achieve different types of effects, such as the aforementioned control of the respective levitation forces 1516-3, 1516-4 to oppose certain rotations. Similarly, as the vehicle 112 may have different propulsion force vs levitation force ratio requirements (e.g. such a ratio may be higher as the vehicle 112 is accelerating from a zero velocity as compared to when the vehicle 112 is at a cruising velocity), and as propulsion forces 310 of the propulsion motors 110-3, 110-4 mounted to a top side of the structures 1400, 1500 may be controlled independent of the propulsion motors 110-3, 110-4, the propulsion forces 310 of the propulsion motors 110-3, 110-4 may be increased or decreased to control such a ratio.

Furthermore, while the configurations of the vehicle 112 include certain numbers of propulsion motors 110 in certain configurations (e.g. according to FIG. 4, FIG. 6 and FIG. 7), the vehicle 112 may be configured with any suitable number of propulsion motors 110 in any suitable respective configurations, with the track 104 adapted accordingly. For example, the vehicle 112 may comprise as few as one propulsion motor 110 that provides a propulsion force 310 and one or more other total forces perpendicular to the propulsion force 310.

Furthermore, while the payload 108 and the structure 1400 are depicted as separate from each other, they may be combined.

Indeed, it is understood that, provided herein is a vehicle 112 configured to move along the track 104, the vehicle 112 comprising: the payload 108; and one or more propulsion motors 110 mounted to the payload 108 (e.g. via the structure 1400), the one or more propulsion motors 110 configured to form, in combination with the track segments of the track 104: a propulsion force 310 in a direction of the track 104; and one or more total forces perpendicular to the propulsion force 310 configured to one or more of oppose gravity and laterally guide the one or more propulsion motors 110 (and/or the payload 108 and/or the vehicle 112) relative to the track 104.

As has already been described, the one or more propulsion motors 110 of the vehicle 112 may respectively comprise: at least one ferromagnetic core having opposite ends joined by a body forming a magnetic flux pathway between the opposite ends; a magnetic flux inducing device to induce a first magnetic flux in the at least one ferromagnetic core along the magnetic flux pathway; and armature coils to induce a varying second magnetic flux in the at least one ferromagnetic core perpendicular to the magnetic flux pathway, to assist inducing a propulsion force perpendicular to the magnetic flux pathway, the at least one ferromagnetic core shaped to form the one or more total forces perpendicular to the propulsion force due to the first magnetic flux.

Indeed, as also understood from FIG. 14, the one or more propulsion motors 110 may comprise: one or more first propulsion motors 110-1, 110-2 mounted to the payload 108 (e.g. which may be via the bogie 1400 when present), the one or more first propulsion motors 110-1, 110-2 configured to form, in combination with first track segments 1402-1, 1402-2 of the track 104: one or more first propulsion forces 310 in the direction of the track 104; and one or more guidance forces 1418-1, 1418-2 perpendicular to the one or more first propulsion forces 310. Furthermore, according to the configuration of FIG. 14, the one or more propulsion motors 110 may further comprise: one or more second propulsion motors 110-3, 110-4 mounted to the payload 108, the one or more second propulsion motors 110-3, 110-4 configured to form, in combination with second track segments 1402-3, 1402-4 of the track 104: one or more second propulsion forces 310 in a direction of the track 104; and one or more levitation forces 1416-1, 1416-2, perpendicular to the one or more second propulsion forces 310 (e.g. and the one or more first propulsion forces 310) and the one or more guidance forces 1418, the one or more levitation forces 1418 opposing gravity.

Indeed, as also understood from FIG. 15, the one or more propulsion motors 110 may comprise: one or more first propulsion motors 110-1, 110-2 mounted to the payload 108, the one or more first propulsion motors 110-1, 110-2 configured to form, in combination with first track segments 1502-1, 1502-2 of the track 104: one or more first propulsion forces 310 in the direction of the track 104; one or more guidance forces 1518-1, 1518-2 perpendicular to the one or more first propulsion forces 310; and one or more first levitation forces 1516-1, 1516-2 perpendicular to the one or more first propulsion forces 310, the one or more first levitation forces 1516-1, 1516-2 opposing gravity. Furthermore, according to the configuration of FIG. 15, the one or more propulsion motors 110 may further comprise: one or more second propulsion motors 110-3, 110-4 mounted to the payload 108, the one or more second propulsion motors 110-3, 110-4 configured to form, in combination with second track segments 1502-3, 1502-4 of the track 104: one or more second propulsion forces 310 in a direction of the track 104; and one or more second levitation forces 1516-3, 1516-4, perpendicular to the one or more second propulsion forces 310 (e.g. and the one or more first propulsion forces 310) and the one or more guidance forces 1518, the one or more second levitation forces 1518 opposing gravity.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that there are yet more alternative examples and modifications possible, and that the above examples are only illustrations of one or more examples. The scope, therefore, is only to be limited by the claims appended hereto.

What is claimed is:

1. A propulsion motor comprising:
at least one ferromagnetic core having opposite ends joined by a body forming a magnetic flux pathway between the opposite ends;
a magnetic flux inducing device to induce a first magnetic flux in the at least one ferromagnetic core along the magnetic flux pathway; and
armature coils to induce a varying second magnetic flux in the at least one ferromagnetic core perpendicular to the magnetic flux pathway, to assist inducing a propulsion force perpendicular to the magnetic flux pathway,
the at least one ferromagnetic core shaped to form one or more total forces perpendicular to the propulsion force due to the first magnetic flux.

2. The propulsion motor of claim 1, wherein the opposite ends of the at least one ferromagnetic core are portions of respective intersecting planes that intersect at an angle that is between 0 degrees, and less than 180 degrees.

3. The propulsion motor of claim 1, wherein the opposite ends of the at least one ferromagnetic core are at about 90 degrees such that the at least one ferromagnetic core form:
a first total force normal to a first end, of the opposite ends; and
a second total force normal to a second end, of the opposite ends,
the first total force and the second total force being about 90 degrees relative to each other.

4. The propulsion motor of claim 1, wherein the body between the opposite ends of the at least one ferromagnetic core may have an about 180 degrees shape, such that the opposite ends are in a same plane and the at least one ferromagnetic core forms:
a first total force normal to a first end, of the opposite ends; and
a second total force normal to a second end, of the opposite ends,
the first total force and the second total force about parallel relative to each other.

5. The propulsion motor of claim 1, wherein the opposite ends of the at least one ferromagnetic core are a given angle relative to a center plane of the at least one ferromagnetic core, such that the at least one ferromagnetic core form:
a first force normal to a first end, of the opposite ends; and
a second force normal to a second end, of the opposite ends,
the first force and the second force summing together to form the one or more total forces perpendicular to the propulsion force.

6. The propulsion motor of claim 5, wherein the given angle is selected such that first components of the first force and the second force, perpendicular to the propulsion force, cancel out, and second components of the first force and the second force, perpendicular to the propulsion force, sum to form a total force perpendicular to the propulsion force.

7. The propulsion motor of claim 1, wherein the opposite ends of the at least one ferromagnetic core form a non-zero angle relative to each other, the opposite ends forming symmetrical mirror-images of each other.

8. The propulsion motor of claim 1, wherein the magnetic flux inducing device comprises one or more of a field coil and a magnet.

9. A propulsion motor comprising:
ferromagnetic cores having respective opposite ends joined by a respective body forming a magnetic flux pathway between the opposite ends;
a magnetic flux inducing device to induce a first magnetic flux in the ferromagnetic cores along the magnetic flux pathway; and
armature coils to induce respective varying second magnetic flux in the ferromagnetic cores perpendicular to the magnetic flux pathway, to assist inducing a propulsion force perpendicular to the magnetic flux pathway,
the ferromagnetic cores arranged in pairs, such that a pair of the ferromagnetic core comprises:
a first ferromagnetic core comprising first opposite ends; and
a second ferromagnetic core comprising second opposite ends,
wherein the first opposite ends and the second opposite ends are about parallel to each other, and are respectively configured to interact with respective ends of a track segment of a track that completes, in combination with the first ferromagnetic core and the second ferromagnetic core, the magnetic flux pathway, and
wherein two respective forces are formed, perpendicular to the first opposite ends and the second opposite ends, and perpendicular to the propulsion force, the two respective forces of about equal magnitude, but opposite in direction, such that a total force on the first opposite ends and the second opposite ends, due to the two respective forces, is zero.

10. A vehicle configured to move along a track, the vehicle comprising:
a payload; and
one or more propulsion motors mounted to the payload, the one or more propulsion motors configured to form, in combination with track segments of the track:
a propulsion force in a direction of the track; and
one or more total forces perpendicular to the propulsion force configured to one or more of oppose gravity and laterally guide the one or more propulsion motors relative to the track.

11. The vehicle of claim 10, wherein the one or more propulsion motors respectively comprise:
at least one ferromagnetic core having opposite ends joined by a body forming a magnetic flux pathway between the opposite ends;
a magnetic flux inducing device to induce a first magnetic flux in the at least one ferromagnetic core along the magnetic flux pathway; and
armature coils to induce a varying second magnetic flux in the at least one ferromagnetic core perpendicular to the magnetic flux pathway, to assist inducing a propulsion force perpendicular to the magnetic flux pathway,
the at least one ferromagnetic core shaped to form the one or more total forces perpendicular to the propulsion force.

12. The vehicle of claim 10, wherein the one or more propulsion motors comprise:
one or more first propulsion motors mounted to the payload, the one or more first propulsion motors configured to form, in combination with first track segments of the track:
one or more first propulsion forces in a direction of the track; and
one or more guidance forces perpendicular to the one or more first propulsion forces; and
one or more second propulsion motors mounted to the payload, the one or more second propulsion motors configured to form, in combination with second track segments of the track:
one or more second propulsion forces in a direction of the track; and
one or more levitation forces, perpendicular to the one or more second propulsion forces and the one or more guidance forces, the one or more levitation forces opposing gravity.

13. The vehicle of claim 10, wherein the one or more propulsion motors comprise:
one or more first propulsion motors mounted to the payload, the one or more first propulsion motors configured to form, in combination with first track segments of the track:
one or more first propulsion forces in a direction of the track; and
one or more guidance forces perpendicular to the one or more first propulsion forces;
and one or more first levitation forces perpendicular to the one or more first propulsion forces, the one or more first levitation forces opposing gravity; and
one or more second propulsion motors mounted to the payload, the one or more second propulsion motors configured to form, in combination with second track segments of the track:
one or more second propulsion forces in a direction of the track; and
one or more second levitation forces, perpendicular to the one or more second propulsion forces and the one or more guidance forces, the one or more second levitation forces opposing gravity.
